(19) United States
(12) Patent Application Publication
(10) Pub. No.: US 2012/0162715 A1
(43) Pub. Date: Jun. 28, 2012

(54) Image Processing Apparatus And Image Processing Method

(75) Inventor: Naoto Shiraishi, Kanagawa (JP)

(73) Assignee: RICOH COMPANY, LIMITED, Tokyo (JP)

(21) Appl. No.: 13/333,274

(22) Filed: Dec. 21, 2011

(30) Foreign Application Priority Data
Dec. 24, 2010 (JP) 2010-287501

(51) Int. Cl. G06K 15/00

(52) U.S. Cl. 358/1.16

(57) ABSTRACT

An image processing apparatus includes: a first storage unit in which a pixel value of each of pixels in image data is written; a readout unit that reads a pixel value of a target pixel to be encoded from the first storage unit; a second storage unit in which the pixel value read by the readout unit is stored; a comparison-result-signal generating unit that compares between each pixel value of the consecutive target pixels and each of the pixel values stored in the second storage unit and that generates a signal; a searching unit that searches the second storage unit for a data string that includes L pieces (L≧2) of the consecutive pixel values that match L pieces of consecutive pixel values of an input data string that includes the consecutive target pixels; and an encoding unit that performs encoding according to a result by the searching unit.

### CROSS-REFERENCE TO RELATED APPLICATIONS

The present application claims priority to and incorporates by reference the entire contents of Japanese Patent Application No. 2010-287501 filed in Japan on Dec. 24, 2010.

### BACKGROUND OF THE INVENTION

1. Field of the Invention

The present invention relates to an image processing apparatus and an image processing method.

2. Description of the Related Art

An image forming apparatus, such as a printer, temporarily stores input image data in a memory, and reads out the image data stored in the memory at predetermined timing to perform printing operation for printing out the image data. In this case, storing image data in a memory without performing any processing requires high capacity for the memory, causing an increase in cost. Therefore, in general, input image data is encoded, and the encoded image data is stored in the memory.

For example, Japanese Patent No. 3922386 discloses a technology of compression encoding using the LZ77 algorithm. More specifically, Japanese Patent No. 3922386 discloses a technology to search a slide storage unit having a plurality of registers, in each of which an input pixel value is stored, for a data string (“list”) that matches two or more consecutive pixel values of an input data string that includes pixel values of a plurality of consecutive target pixels (pixels to be encoded), and encode matched information (information on an address, a length; and the like) of the list.

In the technology disclosed in Japanese Patent No. 3922386, m×n (m by n) pieces of arithmetic circuits (see FIG. 2 of Japanese Patent No. 3922386) are arranged in a matrix form, where the number of pixels included in an input data string is denoted by m, and the number of registers is denoted by n. Each arithmetic circuit is supplied with any one of pixel values included in the input data string and any one of data stored in the registers. Then, the arithmetic circuits execute predetermined arithmetic processing in parallel to search for the list.

However, the technology disclosed in Japanese Patent No. 3922386 has a problem in that each arithmetic circuit includes, in addition to a comparator for making a comparison between a pixel value of the input data string and data stored in the register, a counter for counting the length of a list and a selector for selecting whether or not to output a counter value according to a result of the comparison made by the comparator, so that the size of the circuit becomes large.

The present invention has been made in view of the above; there is a need to provide an image processing apparatus and image processing method capable of simplifying a configuration of a circuit for performing a list search process.

### SUMMARY OF THE INVENTION

It is an object of the present invention to at least partially solve the problems in the conventional technology.

An image processing apparatus includes: a first storage unit in which a pixel value of each of a plurality of pixels included in image data is written; a readout unit that reads out a pixel value of a target pixel to be encoded from the first storage unit; a second storage unit in which the pixel value having been read by the readout unit is stored; a comparison-result-signal generating unit that makes a comparison between each pixel value of a plurality of the consecutive target pixels having been read by the readout unit and each of a plurality of the pixel values having been stored in the second storage unit, and that generates a comparison-result signal representing a result of the comparison as a binary signal; a searching unit that searches the second storage unit for a data string that includes L pieces (L is a natural number equal to or greater than two) of the consecutive pixel values that match L pieces of consecutive pixel values of an input data string that includes each pixel value of a plurality of the consecutive target pixels based on a result of a logical conjunction of L pieces of the comparison-result signals out of a plurality of the comparison-result signals generated by the comparison-result-signal generating unit; and an encoding unit that performs encoding according to a result of a search by the searching unit.

An image processing method includes: reading a pixel value of a target pixel to be encoded from a first storage unit in which each pixel value of a plurality of pixels included in image data is written; comparing between each pixel value of a plurality of the consecutive target pixels read by the reading and each of a plurality of the pixel values that have been stored in a second storage unit in which the pixel values are stored and generating, for each comparison, a comparison-result signal representing a result of the comparison as a binary signal; searching the second storage unit for a data string that includes L pieces (L is a natural number equal to or greater than two) of the, consecutive pixel values that match L pieces of the consecutive pixel values of an input data string that includes each pixel value of a plurality of the consecutive target pixels based on a result of a logical conjunction of L pieces of the comparison-result signals out of a plurality of the comparison-result signals generated by the comparing; and encoding according to a result of a search by the searching.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram showing an example of a configuration of an image forming apparatus that includes electric equipments and a control device according to an embodiment of the present invention;

FIG. 2 is a diagram showing an example of a configuration of an encoding unit;

FIG. 3 is a diagram showing an example of a detailed configuration of a slide/list generation processing unit;

FIG. 4 is a diagram showing an example of a code format;

FIG. 5 is a diagram showing an example of a detailed configuration of a list search processing unit;

FIG. 6 is a diagram for explaining an encoding process according to the embodiment;

FIG. 7 is a flowchart showing an example of detailed contents of discontinuous processing;

FIG. 8 is a diagram showing an example of detailed contents of continuous processing;

FIG. 9 is a diagram showing an example of detailed contents of a slide addition process;

FIG. 10 is a diagram showing an example of detailed contents of the encoding process;

FIG. 11 is a diagram showing an example of detailed contents of a data readout process; and

FIG. 12 is a diagram for explaining a concrete example of the encoding process.

### DETAILED DESCRIPTION OF THE PREFERRED EMBODIMENTS

An exemplary embodiment of an image processing apparatus according to the present invention is explained in detail below with reference to the accompanying drawings. Incidentally, in the present embodiment, a description is given of an example in which the image processing apparatus and image processing method according to the embodiment are applied to an image forming apparatus which is a color printer; however, the image forming apparatus is not limited to a color printer, and includes any image forming apparatuses that perform image processing on an image that includes a text image. For example, the embodiment can be applied to other image forming apparatuses, such as a copying machine, a facsimile, and a multifunction peripheral.

### Example of Printer Applicable to the Embodiment

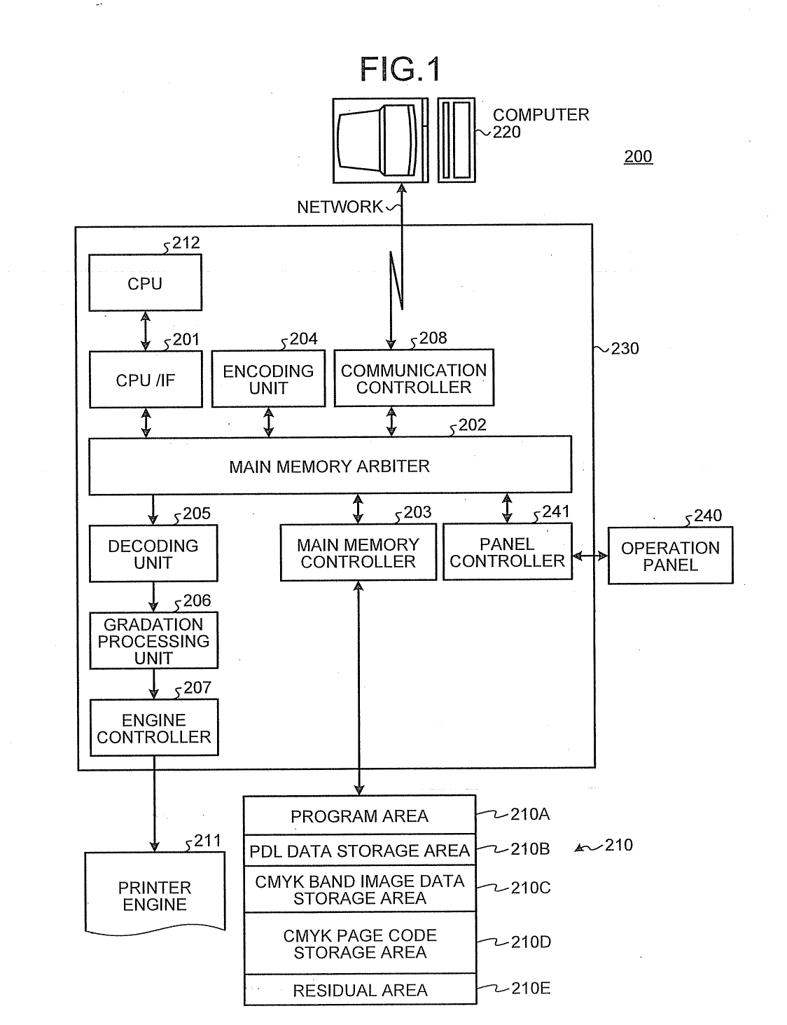

FIG. 1 is a block diagram showing an example of a configuration of electric equipments and a control system of a printer device 200 shown in FIG. 1. In the example of FIG. 1, the printer device 200 includes a control unit 230, a main memory 210, a printer engine 211, and an operation panel 240. The control unit 230 includes a central processing unit (CPU) 212, a CPU I/F 201, a main memory arbiter 202, a main memory controller 203, an encoding unit 204, a decoding unit 205, a gradation processing unit 206, an engine controller 207, a communication controller 208, and a panel controller 241.

The CPU 212 controls the operation of the entire printer device 200 in accordance with a computer program stored in the main memory 210. The CPU 212 is connected to the main memory arbiter 202 via the CPU I/F 201. The main memory arbiter 202 mediates access of the CPU 212, the encoding unit 204, the decoding unit 205, and the communication controller 208 to the main memory 210.

The main memory 210 is connected to the main memory arbiter 202 via the main memory controller 203. The main memory controller 203 controls the access to the main memory 210.

The main memory 210 has a program area 210A, a PDL data storage area 210B (PDL is an abbreviation for a page description language), a CMYK band image data storage area 210C (CMYK is an abbreviation for Cyan, Magenta, Yellow, and blacK), a CMYK page code storage area 210D, and a residual area 210E. In the program area 210A, a computer program for causing the CPU 212 to perform an operation is stored. In the PDL data storage area 210B, PDL data supplied, for example, from a computer 220 via the communication controller 208 is stored. In the CMYK band image data storage area 210C, CMYK band image data is stored. In the CMYK page code storage area 210D, code data that is compressed and encoded band image data is stored. In the CMYK page code storage area 210D, for example, code data that is compressed and encoded CMYK band image data for one page is stored. In the residual area 210E, data other than the above is stored.

The encoding unit 204 encodes band image data to be stored in the main memory 210. Code data that is the encoded band image data is supplied to the main memory 210 via the main memory arbiter 202 and the main memory controller 203, and written in the CMYK page code storage area 210D. The decoding unit 205 reads out the code data from the CMYK page code storage area 210D of the main memory 210 and decodes the read code data in synchronization with the printer engine 211 to be described later. The decoded image data is supplied to the gradation processing unit 206, where gradation processing is performed on the decoded image data, and the processed image data is transferred to the engine controller 207.

The engine controller 207 controls the printer engine 211.

The communication controller 208 controls a communication via a network. For example, page description language (PDL) data output from the computer 220 is received by the communication controller 208 via the network. The communication controller 208 transfers the received PDL data to the main memory 210 via the main memory arbiter 202 and the main memory controller 203.

Incidentally, the network can be a network for communicating in a predetermined range, such as a local area network (LAN), or a network having an extensive range of communications such as the Internet. Furthermore, the network is not limited to a cable communication network, and can be a radio communication network and or serial communication using a Universal Serial Bus (USB), the Institute of Electrical and Electronic Engineers (IEEE) 1394, or the like.

The operation panel 240 has a plurality of manipulanda for accepting a user operation and a display element for providing information to a user. The panel controller 241 controls the display on the operation panel 240 in accordance with an instruction from the CPU 212, and transmits a signal according to a user operation executed through the operation panel 240 to the CPU 212.

### Outline of Encoding Process

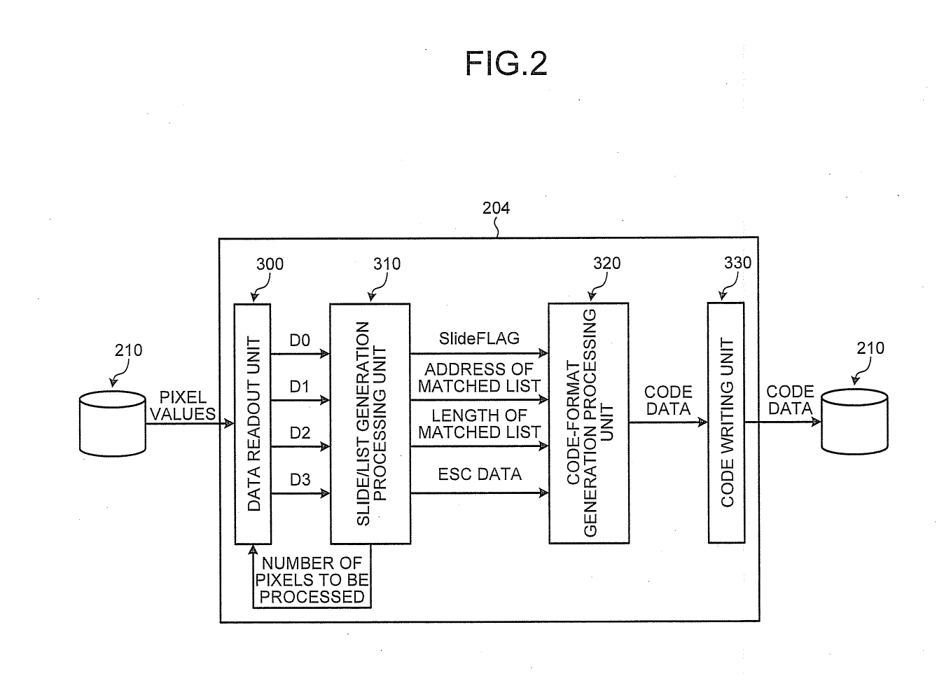

FIG. 2 illustrates an example of a configuration of the encoding unit 204 according to the embodiment. The encoding unit 204 has a data readout unit 300, a slide/list generation processing unit 310, a code-format generation processing unit 320, and a code writing unit 330.

The data readout unit 300 reads out CMYK band image data for each of CMYK color plates from the CMYK band image data storage area 210C in the main memory 210. At this time, the CMYK band image data for each of the CMYK color plates are sequentially read out on a pixel-by-pixel basis at each of scan lines from the CMYK band image data storage area 210C by the data readout unit 300. As will be described in detail later, in the embodiment, the data readout unit 300 first reads out pixel values of four consecutive pixels to be encoded (target pixels), and supplies the read pixel values to the slide/list generation processing unit 310. A data string formed by the pixel values of the four consecutive target pixels is referred to as an input data string; the input data string includes the 0th pixel value D0, the 1st pixel value D1, the 2nd pixel value D2, and the 3rd pixel value D3. Thereafter, the data readout unit 300 reads out pixel value(s), corresponding to the number of pixels to be processed supplied from the slide/list generation processing unit 310, from the main memory 210 at predetermined timing (the timing to execute a data readout process to be described later), and supplies the read pixel value(s) to the slide/list generation processing unit 310.

The slide/list generation processing unit 310 has a slide storage unit for storing pixel values read by the data readout unit 300 according to a first-in first-out (FIFO) method. The slide/list generation processing unit 310 compares each of four pixel values (D0, D1, D2, and D3) included in the input data string supplied from the data readout unit 300 and a corresponding pixel value of previous pixel values stored in the slide storage unit. Then, the slide/list generation processing unit 310 performs a list search process to search the slide storage unit for a data string (called a “list”) that includes consecutively-stored pixel values that match two or more consecutive pixel values in the input data string. Then, the slide/list generation processing unit 310 generates length information Length denoting a length of a list found as a result of the list search process and address information Address denoting an address in the slide storage unit where leading data of the list found as a result of the list search process has been stored, and outputs the length information Length and the address. information Address to the subsequent code-format generation processing unit 320.

On the other hand, if there is no list found as a result of the list search process, the slide/list generation processing unit 310 supplies the 0th (leading) pixel value D0 of the input data string to the subsequent code-format generation processing unit 320 as ESC data. Furthermore, the slide/list generation processing unit 310 supplies a flag SlideFLAG denoting the presence or absence of a list to the subsequent code-format generation processing unit 320. When there is a list found as a result of the list search process, the flag SlideFLAG is set to “1”; on the other hand, when there is no list found, the flag SlideFLAG is set to “0”. Moreover, as will be described later, the slide/list generation processing unit 310 determines the number of pixels to be processed, and supplies the determined number of pixels to be processed to the data readout unit 300.

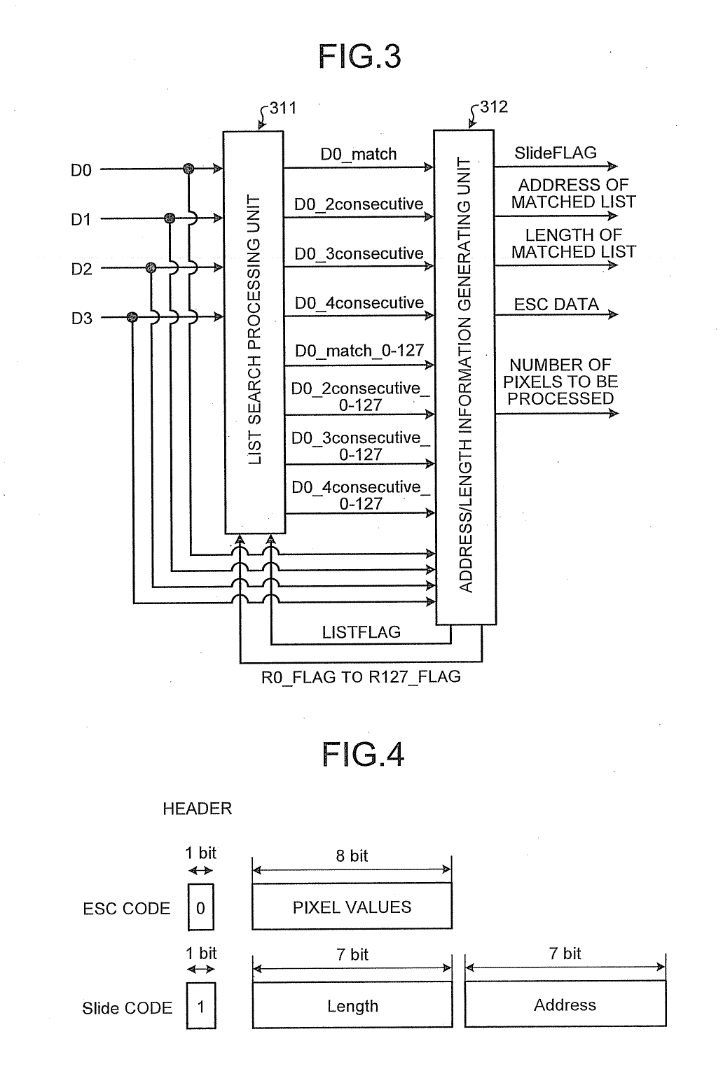

FIG. 3 is a block diagram showing an example of a detailed configuration of the slide/list generation processing unit 310. As shown in FIG. 3, the slide/list generation processing unit 310 has a list search processing unit 311 and an address/length information generating unit 312. The list search processing unit 311 performs the above-described list search process, and supplies various information (to be described later) indicating a result of the list search process to the subsequent address/length information generating unit 312. The address/length information generating unit 312 generates a flag SlideFLAG, address information Address, length information Length, and ESC data on the basis of the various information supplied from the list search processing unit 311, and supplies the generated data to the subsequent code-format generation processing unit 320.

Returning to the explanation of FIG. 2, the code-format generation processing unit 320 generates an ESC code and a Slide code in a format as shown in FIG. 4 from the supplied ESC data, address information Address, length information Length, and a flag SlideFLAG.

The ESC code is encoded ESC data. As shown in FIG. 4, the ESC code is made up of 1-bit data on the flag SlideFLAG set to “0” as the header information and subsequent 8-bit data of pixel values. The Slide code is made up of 1-bit data on the flag SlideFLAG set to “1” as the header information and subsequent 7-bit length information Length and 7-bit address information Address that follow in this order. Incidentally, the code format illustrated in FIG. 4 is just an example, and is not limited thereto.

The ESC code and Slide code generated by the code-format generation processing unit 320 are supplied to the code writing unit 330. The code writing unit 330 writes the supplied ESC code and Slide code in the CMYK page code storage area 210D of the main memory 210 via the main memory arbiter 202 and the main memory controller 203.

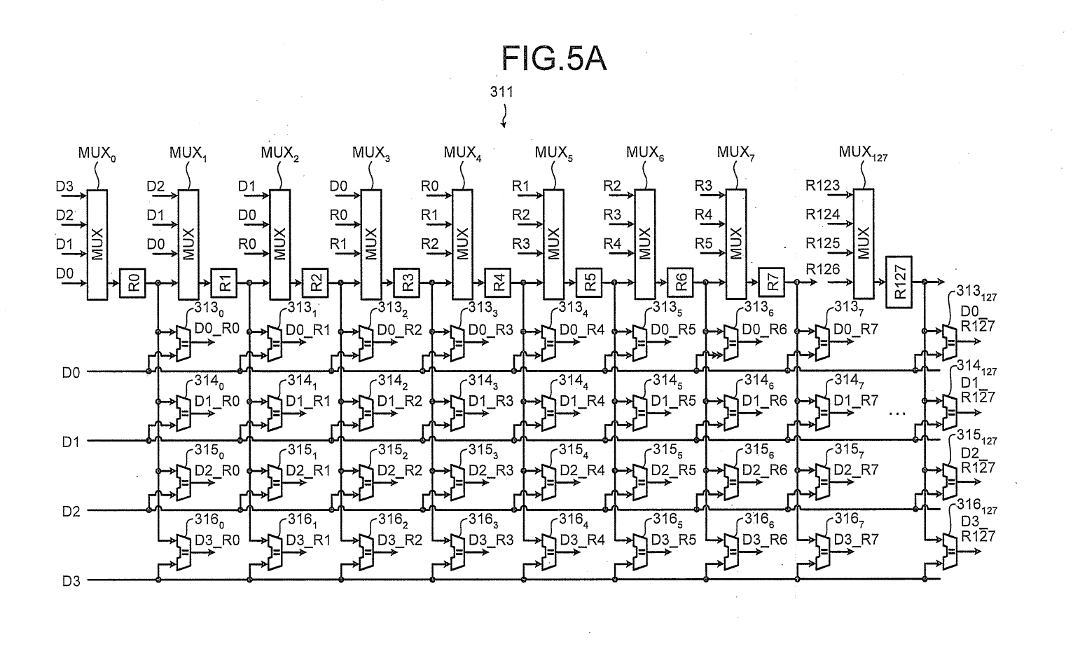

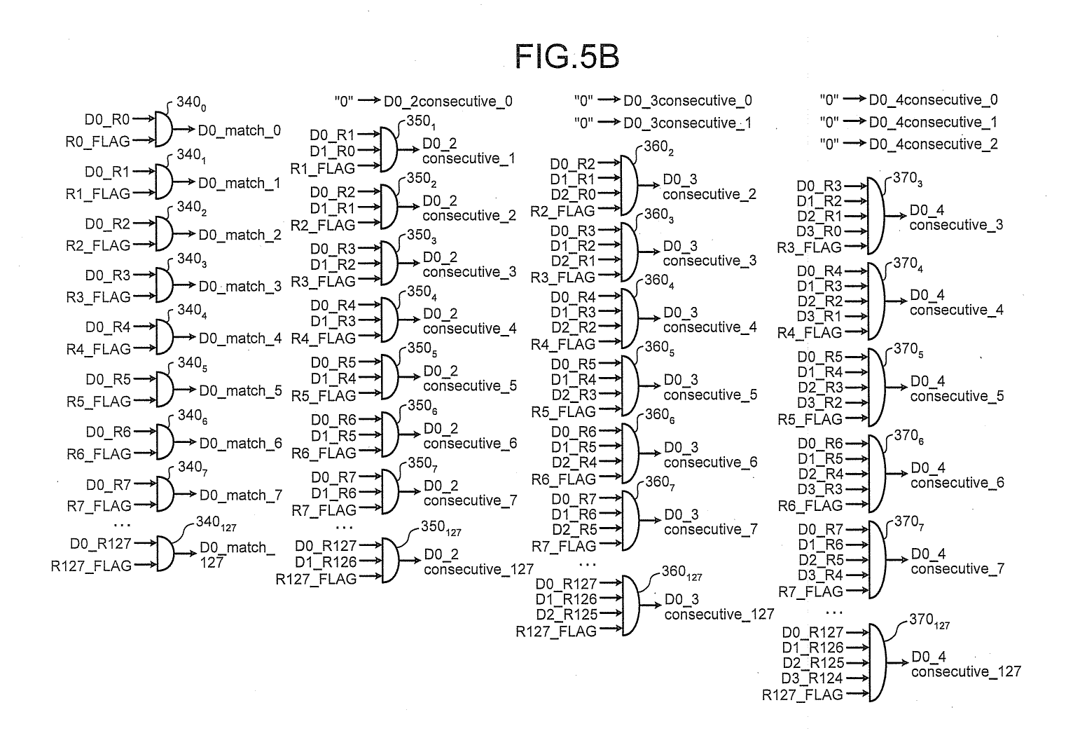

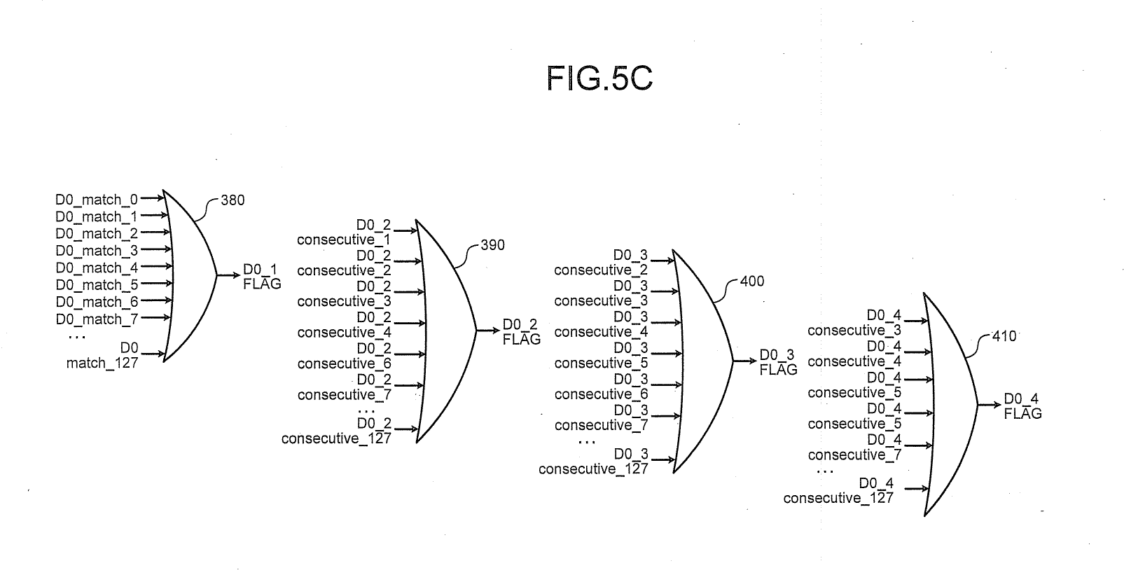

FIG. 5 is a diagram showing an example of a detailed configuration of the list search processing unit 311. As shown in FIG. 5, the list search processing unit 311 has a slide storage unit that includes 128 registers (slides) R0, R1, . . . , R127 each storing therein a unit of data and 128 multiplex circuits MUX₀, MUX₁, . . . , MUX₁₂₇. In the example shown in FIG. 5, each of the multiplex circuits MUX is arranged between two adjacent registers R.

As shown in FIG. 5, the 0th multiplex circuit MUX₀ is supplied with four pixel values (D0, D1, D2, and D3) included in an input data string. More specifically, a first input terminal of the multiplex circuit MUX₀ is supplied with the 0th pixel value D0; a second input terminal is supplied with the 1st pixel value D1; a third input terminal is supplied with the 2nd pixel value D2; a fourth input terminal is supplied with the 3rd pixel value D3.

The 1st multiplex circuit MUX₁ is supplied with data stored in the 0th register R0 and the 0th to 2nd pixel values (D0, D1, and D2) out of the four pixel values included in the input data string. More specifically, a first input terminal of the multiplex circuit MUX₁ is supplied with data stored in the 0th register R0; a second input terminal is supplied with the 0th pixel value D0; a third input terminal is supplied with the 1st pixel value D1; a fourth input terminal is supplied with the 2nd pixel value D2.

The 2nd multiplex circuit MUX₂ is supplied with respective data stored in the 1st and 0th registers R1 and R0 and the 0th and 1st pixel values (D0 and D1) out of the four pixel values included in the input data string. More specifically, a first input terminal of the multiplex circuit MUX₂ is supplied with data stored in the 1st register R1; a second input terminal is supplied with the data stored in the 0th register R0; a third input terminal is supplied with the 0th pixel value D0; a fourth third input terminal is supplied with the 1st pixel value D1.

The 3rd multiplex circuit MUX₃ is supplied with respective data stored in the 0th to 2nd registers R0 to R2 and the 0th pixel value (D0) out of the four pixel values included in the input data string. More specifically, a first input terminal of the multiplex circuit MUX₃ is supplied with data stored in the 2nd register R2; a second input terminal is supplied with the data stored in the 1st register R1; a third input terminal is supplied with the data stored in the 0th register R0; a fourth input terminal is supplied with the 0th pixel value D0.

The m-th (4≦m≦127) multiplex circuit MUXₘ is supplied with respective data stored in the (m-1)th to (m-4)th registers Rm-1 to Pm-4. More specifically, a first input terminal of the multiplex circuit MUXₘ is supplied with data stored in the (m-1)th register Pm-1; a second input terminal is supplied with data stored in the (m-2)th register Rm-2; a third input terminal is supplied with data stored in the (m-3)th register Pm-3; a fourth input terminal is supplied with data stored in the (m-4)th register Rm-4.

When a slide addition process to be described later is executed, the multiplex circuits MUX are supplied with the same number of pixels to be processed. When the supplied number of pixels to be processed is “1”, each multiplex circuit MUX selects data supplied to the first input terminal and outputs the selected data. This shifts memory content of each slide R (R0 to R127) immediately in front of each multiplex circuit MUX to the left in FIG. 5 by one. When the supplied number of pixels to be processed is “2”, each multiplex circuit MUX selects data supplied to the second input terminal and outputs the selected data. This shifts memory content of each slide R (R0 to R127) immediately in front of each multiplex circuit MUX to the left in FIG. 5 by two. When the supplied number of pixels to be processed is “3”, each multiplex circuit MUX selects data supplied to the third input terminal and outputs the selected data. This shifts memory content of each slide R (R0 to R127) immediately in front of each multiplex circuit MUX to the left in FIG. 5 by three. When the supplied number of pixels to be processed is “4”, each multiplex circuit MUX selects data supplied to the fourth input terminal and outputs the selected data. This shifts memory content of each slide R (R0 to R127) immediately in front of each multiplex circuit MUX to the left in FIG. 5 by four.

Furthermore, as shown in FIG. 5, the list search processing unit 311 has 128 comparators 313₀, 313₁, . . . , 313₁₂₇, 128 comparators 314₀, 314₁, . . . , 314₁₂₇, 128 comparators 315₀, 315₁, . . . , 315₁₂₇, and 128 comparators 316₀, 316₁, . . . , 316₁₂₇. Each of the comparators (313, 314, 315, and 316) compares data input to one of input terminals thereof and data input to the other input terminal, and outputs a value “1” if the both data match or outputs a value “0” if the both data do not match.

Outputs of the registers R0, R1, . . . , R127 are input to the one input terminals of the comparators 313₀, 313₁, . . . , 313₁₂₇, respectively. For example, output of the x-th (0≦x≦127) register Rx is input to the one input terminal of the x-th comparator 313ₓ. Furthermore, the 0th pixel value D0 out of the four pixel values included in the input data string is input to the other input terminals of the comparators 313₀, 313₁, . . . 313₁₂₇. Here, output of the x-th comparator 313ₓ is denoted by D0_Rx; when output D0_Rx is “1”, it indicates that the 0th pixel value D0 matches data stored in the x-th register Rx. On the other hand, when output D0_Rx is “0”, it indicates that the 0th pixel value D0 does not match data stored in the x-th register Rx.

The outputs of the registers R0, R1, . . . , R127 are input to the one input terminals of the comparators 314₀, 314₁, . . . , 314₁₂₇, respectively. Furthermore, the 1st pixel value D1 out of the four pixel values included in the input data string is input to the other input terminals of the comparators 314₀, 314₁, . . . , 314₁₂₇. Here, output of the x-th comparator 314ₓ is denoted by D1_Rx; when output D1_Rx is “1”, it indicates that the 1st pixel value D1 matches data stored in the x-th register Rx. On the other hand, when output D1_Rx is “0”, it indicates that the 1st pixel value D1 does not match data stored in the x-th register Rx.

The outputs of the registers R0, R1, . . . , R127 are input to the one input terminals of the comparators 315₀, 315₁, . . . , 315₁₂₇, respectively. Furthermore, the 2nd pixel value D2 out of the four pixel values included in the input data string is input to the other input terminals of the comparators 315₀, 315₁, . . . , 315₁₂₇. Here, output of the x-th comparator 315ₓ is denoted by D2_Rx; when output D2_Rx is “1”, it indicates that the 2nd pixel value D2 matches data stored in the x-th register Rx. On the other hand, when output D2_Rx is “0”, it indicates that the 2nd pixel value D2 does not match data stored in the x-th register Rx.

The outputs of the registers R0, R1, . . . , R127 are input to the one input terminals of the comparators 316₀, 316₁, . . . , 316₁₂₇, respectively. Furthermore, the 3rd pixel value D3 out of the four pixel values included in the input data string is input to the other input terminals of the comparators 316₀, 316₁, . . . , 316₁₂₇. Here, output of the x-th comparator 316ₓ is denoted by D3_Rx; when output D3_Rx is “1”, it indicates that the 3rd pixel value D3 matches data stored in the x-th register. Rx. On the other hand, when output D3_Rx is “0”, it indicates that the 3rd pixel value D3 does not match data stored in the x-th register Rx.

In the embodiment, the list search processing unit 311 searches the slide storage unit for a data string (a “list”) that includes L consecutively-stored pixel values that match L consecutive pixel values of the input data string (D0, D1, D2, D3) on the basis of the logical conjunction of L (2≦L≦4, in this embodiment) outputs out of the outputs from the comparators (313, 314, 315, and 316).

For example, when the logical conjunction of output D0_Rx indicating a result of comparison between data stored in the x-th register Rx and the 0th pixel value D0 and output D1_Rx-1 indicating a result of comparison between data stored in the (x-1)th register Rx-1 and the 1st pixel value D1 is “1”, it is identified that a list that includes the consecutive 0th and 1st pixel values D0 and D1 is present in the slide storage unit. Furthermore, for example, when the logical conjunction of the output D0_Rx, the output D1_Rx-1, and output D2_Rx-2 indicating a result of comparison between data stored in the (x-2)th register Rx-2 and the 2nd pixel value D2 is “1”, it is identified that a list that includes the consecutive 0th to 2nd pixel values D0, D1, and D2 is present in the slide storage unit. Moreover, for example, when the logical conjunction of the output D0_Rx, the output D1_Rx-1, the output D2_Rx-2, and output D3_Rx-3 indicating a result of comparison between data stored in the (x-3)th register Rx-3 and the 3rd pixel value D3 is “1”, it is identified that a list that includes the consecutive 0th to 3rd pixel values D0, D1, D2, and D3 is present in the slide storage unit. The concrete contents are described below.

As shown in FIG. 5, the list search processing unit 311 has 128 AND gates (AND circuits) 340₀, 340₁, . . . , 340₁₂₇, 127 AND gates 350₁, 350₂, . . . , 350₁₂₇, 126 AND gates 360₂, 360₃, . . . , 360₁₂₇, and 125 AND gates 370₃, 370₄, . . . , 370₁₂₇. As can be seen from FIG. 5, output of the x-th comparator 313_x is input to one of input terminals of the x-th AND gate 340ₓ, and a flag Rx_FLAG denoting the availability of the x-th register Rx is input to the other input terminal. When output of the x-th AND gate 340ₓ is “1”, a flag D0match_x denoting that the 0th pixel value D0 matches data stored in the x-th register Rx is set to “1” (is enabled). On the other hand, when output of the AND gate 340ₓ is “0”, the flag D0match_x is set to “0” (is disabled). Respective outputs (flags D0match_x) of the AND gates 340₀, 340₁, . . . , 340₁₂₇ are supplied to an OR gate 380 to be described later and the subsequent address/length information generating unit 312.

As can be seen from FIG. 5, a flag Rj_FLAG denoting the availability of the j-th register Rj is input to a first input terminal of the j-th (1≦j—127) AND gate 350ⱼ; output of the (j-1)th comparator 314ⱼ₋₁ is input to a second input terminal; output of the j-th comparator 313ⱼ is input to a third input terminal. When output of the j-th AND gate 350ⱼ is “1”, it means that data stored in the j-th register Rj matches the 0th pixel value D0, and data stored in the (j-1)th register Rj-1 matches the 1st pixel value D1. Therefore, when output of the AND gate 350ⱼ is “1”, a data string (a list) that includes the consecutive 0th and 1st pixel values D0 and D1 is present in the slide storage unit, and a flag D0_2consecutive_j indicating that the pixel value D0, leading data of the data string, has been stored in the j-th register Rj is set to “1” (is enabled). On the other hand, when output of the AND gate 350ⱼ is “0”, the flag D0_2consecutive_j is set to “0” (is disabled). Respective outputs (flags D0_2consecutive_j) of the AND gates 350₁, 350₂, . . . , 350₁₂₇ are supplied an OR gate 390 to be described later and the subsequent address/length information generating unit 312.

Furthermore, as can be seen from FIG. 5, a flag Rk_FLAG denoting the availability of the k-th register Rk is input to a first input terminal of the k-th (2≦k≦127) AND gate 360ₖ; output of the (k-2)th comparator 315ₖ₋₂ is input to a second input terminal; output of the (k-1)th comparator 314ₖ₋₁ is input to a third input terminal; output of the k-th comparator 313ₖ is input to a fourth input terminal. When output of the k-th AND gate 360ₖ is “1”, it means that data stored in the k-th register Rk matches the 0th pixel value D0, data stored in the (k-1)th register Rk-1 matches the 1st pixel value D1, and data stored in the (k-2)th register Rk-2 matches the 2nd pixel value D2. Therefore, when output of the k-th AND gate 360ₖ is “1”, a data string that includes the three consecutive 0th to 2nd pixel values D0, D1, and D2 is present in the slide storage unit, and a flag D0_3consecutive_k indicating that the pixel value D0, leading data of the data string, has been stored in the k-th register Rk is set to “1” (is enabled). On the other hand, when output of the AND gate 360ₖ is “0”, the flag D0_3consecutive_k is set to “0” (is disabled). Respective outputs (flags D0_3consecutive_k) of the AND gates 360₂, 360₃, . . . , 360₁₂₇ are supplied an OR gate 400 to be described later and the subsequent address/length information generating unit 312.

Moreover, as can be seen from FIG. 5, a flag Rp_FLAG denoting the availability of the p-th register Rp is input to a first input terminal of the p-th (3≦p≦127) AND gate 370ₚ; output of the (p-3)th comparator 316ₚ₋₃ is input to a second input terminal; output of the (p-2)th comparator 315ₚ₋₂ is input to a third input terminal; output of the (p-1)th comparator 314ₚ₋₁ is input to a fourth input terminal; output of the p-th comparator 313ₚ is input to a fifth input terminal. When output of the p-th AND gate 370ₚ is “1”, it means that data stored in the p-th register Rp matches the 0th pixel value D0, data stored in the (p-1)th register Rp-1 matches the 1st pixel value D1, data stored in the (p-2)th register Rp-2 matches the 2nd pixel value D2, and data stored in the (p-3)th register Rp-3 matches the 3rd pixel value D3. Therefore, when output of the p-th AND gate 370ₚ is “1”, a data string that includes the four consecutive 0th to 3rd pixel values D0, D1, D2, and D3 is present in the slide storage unit, and a flag D0_4consecutive_p indicating that the pixel value D0, leading data of the data string, has been stored in the p-th register Rp is set to “1” (is enabled). On the other hand, when output of the AND gate 370ₚ is “0”, the flag D0_4consecutive_p is set to “0” (is disabled). Respective outputs of the AND gates 370₃, 370₄, . . . , 370₁₂₇ are supplied an OR gate 410 to be described later and the subsequent address/length information generating unit 312.

As shown in FIG. 5, in the embodiment, the list search processing unit 311 has the OR gate (OR circuit) 380, the OR gate 390, the OR gate 400, and the OR gate 410. Respective outputs of the AND gates 340₀, 340₁, . . . , 340₁₂₇ are input to the OR gate 380. When at least any one of the outputs of the AND gates 340₀, 340₁, . . . , 340₁₂₇ is “1”, output of the OR gate 380 is “1”, and a value of a flag D0_1FLAG is set to “1” (a flag D0_1FLAG is enabled). The flag D0_1FLAG is enabled, which indicates that the register R in which the same pixel value as the 0th pixel value D0 has been stored is present. On the other hand, when output of the OR gate 380 is “0”, a value of the flag D0_1FLAG is set to “0” (the flag D0_1FLAG is disabled). The output of the OR gate 380 is supplied to the subsequent address/length information generating unit 312.

Respective outputs of the AND gates 350₁, 350₂, . . . , 350₁₂₇ are input to the OR gate 390. When at least any one of the outputs of the AND gates 350, 350₂, . . . , 350₁₂₇ is “1”, output of the OR gate 390 is “1”, and a value of a flag D0_2FLAG is set to “1” (a flag D0_2FLAG is enabled). The flag D0_2FLAG is enabled, which indicates that a data string matching the data string (D0, D1) that includes the consecutive 0th and 1st pixel values D0 and D1 is present in the slide storage unit. On the other hand, when output of the OR gate 390 is “0”, the flag D0_2FLAG is set to “0” (is disabled). The output of the OR gate 390 is supplied to the subsequent address/length information generating unit 312.

Respective outputs of the AND gates 360₂, 350₃, . . . , 350₁₂₇ are input to the OR gate 400. When at least any one of the outputs of the AND gates 360₂, 360₃, . . . , 360₁₂₇ is “1”, output of the OR gate 400 is “1”, and a flag D0_3FLAG is set to “1” (is enabled). The flag D0_3FLAG is enabled, which indicates that a data string matching the data string (D0, D1, D2) that includes the consecutive 0th to 2nd pixel values D0, D1, and D2 is present in the slide storage unit. On the other hand, when output of the OR gate 400 is “0”, a value of the flag D0_3FLAG is set to “0” (the flag D0_3FLAG is disabled). The output of the OR gate 400 is supplied to the subsequent address/length information generating unit 312.

Respective outputs of the AND gates 370₃, 370₄, . . . , 370₁₂₇ are input to the OR gate 410. When at least any one of the outputs of the AND gates 370₃, 370₄, . . . , 370₁₂₇ is “1”, output of the OR gate 410 is “1”, and a flag D0_4FLAG is set to “1” (is enabled). The flag D0_4FLAG is enabled, which indicates that a data string matching the data string (D0, D1, D2, D3) that includes the consecutive 0th to 3rd pixel values D0, D1, D2, and D3 is present in the slide storage unit. On the other hand, when output of the OR gate 410 is “0”, the flag D0_4FLAG is set to “0” (is disabled). The output of the OR gate 410 is supplied to the subsequent address/length information generating unit 312.

In such a configuration, the list search process is performed as follows. First, comparisons between the 0th pixel value D0 of the input data string and previous pixel values stored in the registers R0, R1, . . . , R127 made by the comparators 313₀, 313₁, . . . , 313₁₂₇, comparisons between the 1st pixel value D1 of the input data string and the previous pixel values stored in the registers R0, R1, . . . , R127 made by the comparators 314₀, 314₁, . . . , 314₁₂₇, comparisons between, the 2nd pixel value D2 of the input data string and the previous pixel values stored in the registers R0, R1, . . . , R127 made by the comparators 315₀, 315₁, . . . , 315₁₂₇, and comparisons between the 3rd pixel value D3 of the input data string and the previous pixel values stored in the registers R0, R1, . . . , R127 made by the comparators 316₀, 316₁, . . . , 316₁₂₇ are performed in parallel.

Then, results of the comparisons made by the comparators (313, 314, 315, and 316) are supplied to the input side of the corresponding AND gates (340, 350, 360, and 370), and flags (D0_match_x, D0_2consecutive_j, D0_3consecutive_k, D0_4consecutive_p) are output. The flags are supplied to the subsequent address/length information generating unit 312, and also supplied to the input. side of the corresponding OR gates (380, 390, 400, and 410), and the OR gates output different flags (D0_1FLAG, D0_2FLAG, D0_3FLAG, D0_4FLAG). The flags (D0_1FLAG, D0_2FLAG, D0_3FLAG, and D0_4FLAG) output from the OR gates (380, 390, 400, and 410) are supplied to the subsequent address/length information generating unit 312. According to the configuration shown in FIG. 5, this series of processing can be executed in one clock.

### Details of Encoding Process

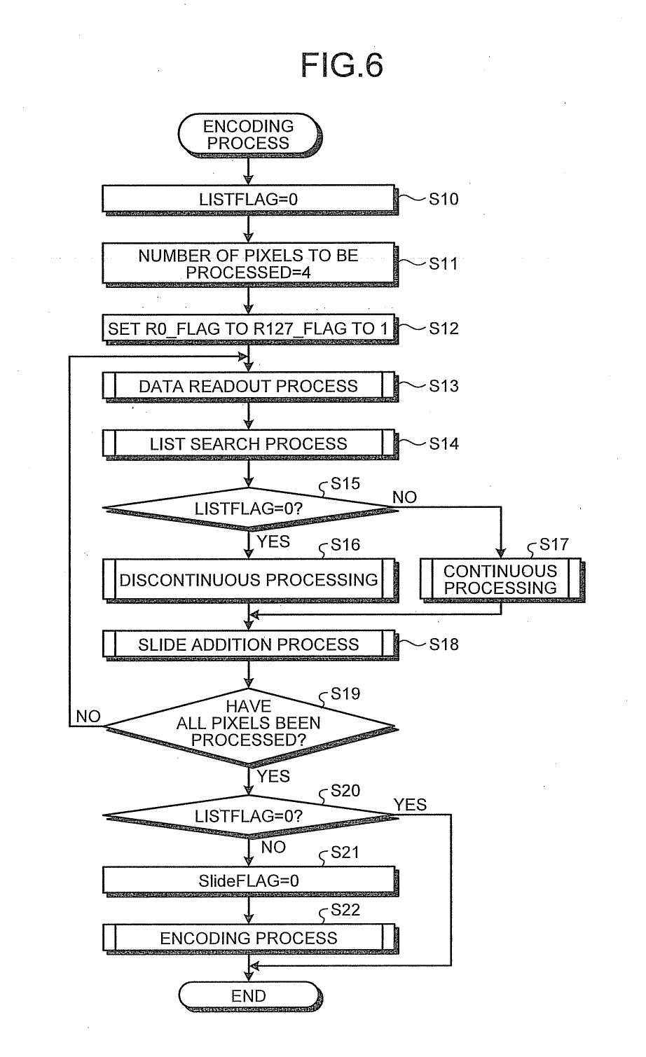

Subsequently, the encoding process performed in the encoding unit 204 according to the embodiment is explained in more detail. FIG. 6 is an example of a flowchart showing the flow of the entire encoding process according to the embodiment. At the first Step S10, a flag LISTFLAG, indicating which one of continuous processing and discontinuous processing to be described later is valid, is initialized to a value “0” indicating that the discontinuous processing is performed. At the next Step S11, the slide/list generation processing unit 310 sets the number of pixels to be processed, that is the number of target pixels to be read by the data readout unit 300, to an initial value of “4”, and supplies the set number of pixels to be processed to the data readout unit 300. At the next Step S12, the slide/list generation processing unit 310 makes all the flags Rx_FLAG (x=0 to 127) valid. More specifically, the address/length information generating unit 312 (see FIG. 3) sets values of all the flags Rx_FLAG (x=0 to 127) to “1”, and supplies the flags Rx_FLAG set to “1” to the AND gates (340, 350, 360, and 370) of the list search processing unit 311.

At the next Step S13, the data readout unit 300 performs the data readout process on the basis of the number of pixels to be processed supplied from the slide/list generation processing unit 310, and supplies an input data string to the slide/list generation processing unit 310. Detailed contents of the data readout process will be described later. At the next Step S14, the slide/list generation processing unit 310 (the list search processing unit 311) performs the above-described list search process. At the next Step S15, it is determined whether the flag LISTFLAG is “0”; when it is determined that the flag LISTFLAG is “0”, the process proceeds to Step S16. At Step S16, the slide/list generation processing unit 310 (the address/length information generating unit 312) performs discontinuous processing. Detailed contents of the discontinuous processing will be described later. Then, the process proceeds to Step S18.

On the other hand, at the above Step S15, when it is determined that the flag LISTFLAG is not “0”, the process proceeds to Step S17. At Step S17, the slide/list generation processing unit 310 (the address/length information generating unit 312) performs continuous processing. Detailed contents of the continuous processing will be described later. Then, the process proceeds to Step S18.

At Step S18, the slide/list generation processing unit 310 performs the slide addition process to shift memory contents of the registers (slides) R0 to R127 in the slide storage unit to the other end side by a number corresponding to the number of pixels to be processed newly determined in the discontinuous processing or continuous processing to be described later and add as many pixel values out of four pixel values included in the input data string as a number corresponding to the newly-determined number of pixels to be processed to the registers sequentially from the register at one end of the slide storage unit. Detailed contents of the slide addition process will be described later. The process proceeds to Step S19 at which it is determined whether the processes on all the pixels have been completed. When it is determined that the processes on all the pixels have not been completed, the process returns to the Step S13 above. On the other hand, when it is determined that the processes on all the pixels have been completed, the process proceeds to Step S20.

At Step S20, it is determined whether the flag LISTFLAG is “0”. When it is determined that the flag LISTFLAG is not “0”, the process proceeds to Step S21 at which a flag SlideFLAG denoting the presence or absence of a list is set to “0”. Then, the process proceeds to Step S22 at which the encoding process is performed by the code-format generation processing unit 320. Detailed contents of the encoding process will be described later. On the other hand, at the Step S20 above, when it is determined that the flag LISTFLAG is “0”, a series of the encoding processes ends.

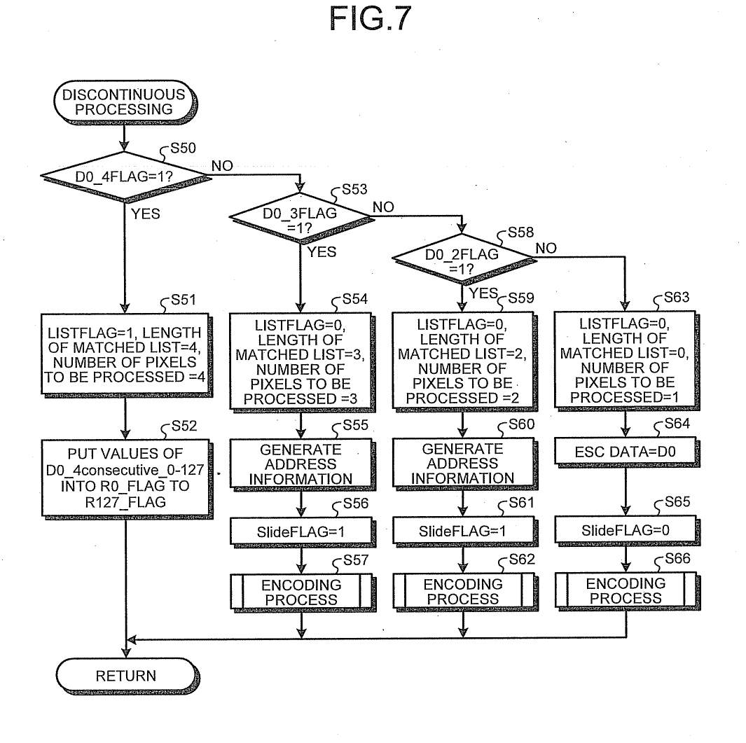

FIG. 7 is a flowchart showing detailed contents of the discontinuous processing performed at Step S16 in FIG. 6. First, at Step S50, the address/length information generating unit 312 determines whether a value of a flag D0_4FLAG supplied from the list search processing unit 311 is “1”. When it is determined that the value of the flag D0_4FLAG is “1”, the process proceeds to Step S51. At Step S51, the address/length information generating unit 312 sets the flag LISTFLAG to “1”, and sets length information Length to “4”. Furthermore, the address/length information generating unit 312 sets the number of pixels to be processed to “4”. Namely, when a list (D0, D1, D2, D3) that includes pixel values of four consecutive target pixels is found as a result of the above-described list search process, the number of target pixels to be read by the data readout unit 300 in the next readout is set to “4”. Then, the process proceeds to Step S52 at which the address/length information generating unit 312 keeps a value of a flag Rp_FLAG, which indicates the availability of a register Rp corresponding to a flag D0_4consecutive_p set to “1”, to “1”, and sets values of flags R_FLAG indicating the availability of the other registers R to “0”.

At the above Step S50, when it is determined that the value of the flag D0_4FLAG is not “1”, i.e., the value of the flag D0_4FLAG is “0”, the process proceeds to Step S53. At Step S53, the address/length information generating unit 312 determines whether a value of a flag D0_3FLAG supplied from the list search processing unit 311 is “1”. When it is determined that the value of the flag D0_3FLAG is “1”, the process proceeds to Step S54. At Step S54, the address/length information generating unit 312 sets the flag LISTFLAG to “0”, and sets length information Length to “3”. Furthermore, the address/length information generating unit 312 sets the number of pixels to be processed to “3”. Namely, when a list (D0, D1, D2) that includes pixel values of three consecutive target pixels is found as a result of the above-described list search process, the number of target pixels to be read by the data readout unit 300 in the next readout is set to “3”. Then, the process proceeds to Step S55 at which the address/length information generating unit 312 generates address information Address denoting an address of a register Rk corresponding to a flag D0_3consecutive_k set to “1” in the slide storage unit. If there is a plurality of flags D0_3consecutive_k set to “1”, the address/length information generating unit 312 generates address information Address of a register R closest to the 0th register R0 out of registers R corresponding to the flags D0_3consecutive_k set to “1”.

The process proceeds to Step S56; at Step S56, the address/length information generating unit 312 sets a flag SlideFLAG to “1”. The address/length information generating unit 312 supplies the length information Length set at the above Step S54, the address information Address generated at the above Step S55, and the flag SlideFLAG set to “1” at the above Step S56 to the subsequent code-format generation processing unit 320. Then, the process proceeds to Step S57; at Step S57, the code-format generation processing unit 320 performs the encoding process to be described later.

At the above Step S53, when it is determined that the value of the flag D0_3FLAG is not “1”, i.e., the value of the flag D0_3FLAG is “0”, the process proceeds to Step S58. At Step S58, the address/length information generating unit 312 determines whether a value of a flag D0_2FLAG supplied from the list search processing unit 311 is “1”. When it is determined that the value of the flag D0_2FLAG is “1”, the process proceeds to Step S59. At Step S59, the address/length information generating unit 312 sets the flag LISTFLAG to “0”, and sets length information Length to “2”. Furthermore, the address/length information generating unit 312 sets the number of pixels to be processed to “2”. Namely, when a list (D0, D1) formed by pixel values of two consecutive target pixels is found as a result of the above-described list search process, the number of target pixels to be read by the data readout unit 300 in the next readout is set to “2”. Then, the process proceeds to Step S60 at which the address/length information generating unit 312 generates address information Address denoting an address of a register Rj corresponding to a flag D0_2consecutive_j set to “1” in the slide storage unit. If there is a plurality of flags D0_2consecutive_j having been set to “1”, the address/length information generating unit 312 generates address information Address of a register R closest to the 0th register R0 out of registers R corresponding to the flags D0_2consecutive_j set to “1”.

The process proceeds to Step S61; at Step S61, the address/length information generating unit 312 sets the flag SlideFLAG to “1”. The address/length information generating unit 312 supplies the length information Length having been set at the above Step S59, the address information Address having been generated at the Step S60 described above, and the flag SlideFLAG having been set to “1” at the Step S61 described above to the subsequent code-format generation processing unit 320. Then, the process proceeds to Step S62; at Step S62, the code-format generation processing unit 320 performs the encoding process to be described later.

At the Step S58 described above, when it is determined that the value of the flag D0_2FLAG is not “1”, i.e., the value of the flag D0_2FLAG is “0”, and no list is present in the slide storage unit, the process proceeds to Step S63. At Step S63, the address/length information generating unit 312 sets the flag LISTFLAG to “0”, and sets length information Length to “0”. Furthermore, the address/length information generating unit 312 sets the number of pixels to be processed to “1”. Namely, when no list is found as a result of the above-described list search process, the number of target pixels to be read by the data readout unit 300 in the next readout is set to “1”. Then, the process proceeds to Step S64; at Step S64, the address/length information generating unit 312 sets the 0th (leading) pixel value D0 of the input data string as the ESC data. At the next step S65, the address/length information generating unit 312 sets the SlideFLAG to “0”. The address/length information generating unit 312 supplies the ESC data having been set at the Step S64 described above and the SlideFLAG having been set to “0” at the Step S65 described above to the subsequent code-format generation processing unit 320. Then, the process proceeds to Step S66; at Step S66, the code-format generation processing unit 320 performs the encoding process to be described later.

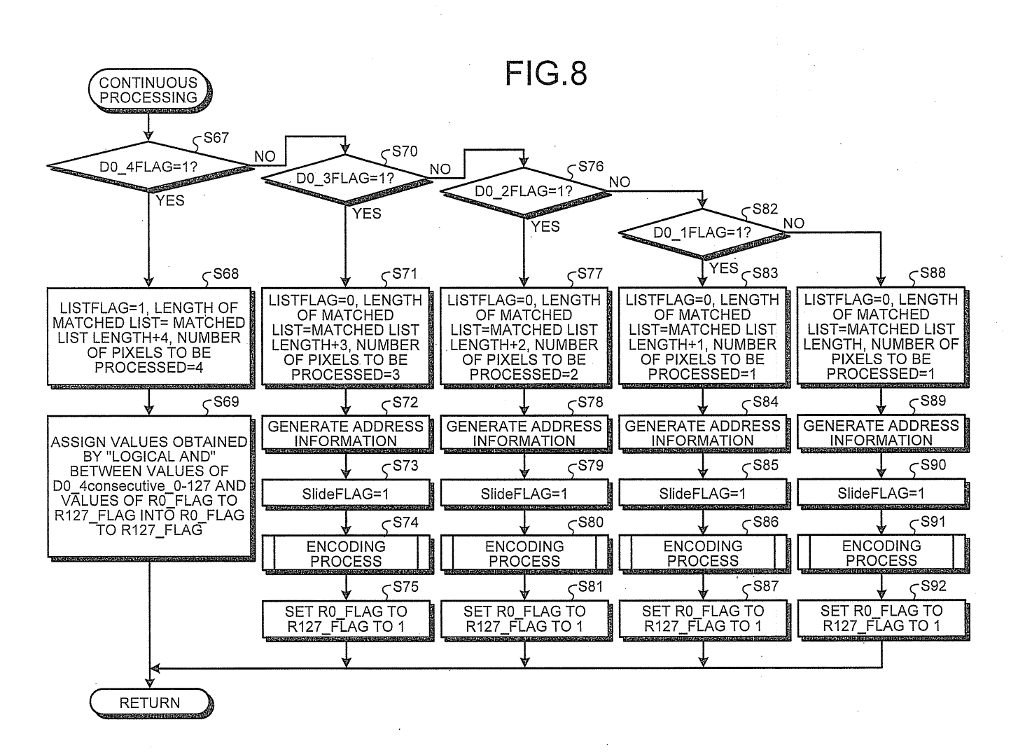

FIG. 8 is a flowchart showing detailed contents of the continuous processing performed at Step S17 in FIG. 6. First, at Step S67, the address/length information generating unit 312 determines whether a value of a flag D0_4FLAG supplied from the list search processing unit 311 is “1”. When it is determined that the value of the flag D0_4FLAG is “1”, the process proceeds to Step S68. At Step S68, the address/length information generating unit 312 sets the flag LISTFLAG to “1”. Furthermore, the address/length information generating unit 312 sets a value obtained by adding “4” to the last length information Length as new length information Length. Moreover, the address/length information generating unit 312 sets the number of pixels to be processed to “4”. Then, the process proceeds to Step S69 at which the address/length information generating unit 312 keeps a value of a flag Rp_FLAG, which indicates the availability of a register Rp corresponding to a flag D0_4consecutive_p set to “1”, to “1”, and sets values of flags R_FLAG indicating the availability of the other registers R to “0”.

At the Step S67 described above, when it is determined that the value of the flag D0_4FLAG is not “1”, i.e., the value of the flag D0_4FLAG is “0”, the process proceeds to Step S70. At Step S70, the address/length information generating unit 312 determines whether a value of a flag D0_3FLAG supplied from the list search processing unit 311 is “1”. When it is determined that the value of the flag D0_3FLAG is “1”, the process proceeds to Step S71. At Step S71, the address/length information generating unit 312 sets the flag LISTFLAG to “0”. Furthermore, the address/length information generating unit 312 sets a value obtained by adding “3” to the last length information Length as new length information Length. Moreover, the address/length information generating unit 312 sets the number of pixels to be processed to “3”. Then, the process proceeds to Step S72 at which the address/length information generating unit 312 generates address information Address denoting an address of a register Rk corresponding to a flag D0_3consecutive_k having been set to “1” in the slide storage unit. If there is a plurality of flags D0_3consecutive_k having been set to “1”, the address/length information generating unit 312 generates address information Address of a register R closest to the 0th register R0 out of registers R corresponding to the flags D0_3consecutive_k having been set to “1”.

The process proceeds to Step S73; at Step S73, the address/length information generating unit 312 sets a flag SlideFLAG to “1”. The address/length information generating unit 312 supplies the length information Length having been set at the Step S71 described above, the address information Address generated at the Step S72 described above, and the flag SlideFLAG set to “1” at the Step S73 described above to the subsequent code-format generation processing unit 320. Then, the process proceeds to Step S74; at Step S74, the code-format generation processing unit 320 performs the encoding process to be described later. The process proceeds to Step S75; at Step S75, the address/length information generating unit 312 sets values of all flags Rx_FLAG (x=0 to 127) to “1”, and supplies the flags Rx_FLAG (x=0 to 127) set to “1” to the list search processing unit 311.

At the Step S70 described above, when it is determined that the value of the flag D0_3FLAG is not “1”, i.e., the value of the flag D0_3FLAG is “0”, the process proceeds to Step S76. At Step S76, the address/length information generating unit 312 determines whether a value of a flag D0_2FLAG supplied from the list search processing unit 311 is “1”. When it is determined that the value of the flag D0_2FLAG is “1”, the process proceeds to Step S77. At Step S77, the address/length information generating unit 312 sets the flag LISTFLAG to “0”. Furthermore, the address/length information generating unit 312 sets a value obtained by adding “2” to the last length information Length as new length information Length. Moreover, the address/length information generating unit 312 sets the number of pixels to be processed to “2”. Then, the process proceeds to Step S78 at which the address/length information generating unit 312 generates address information Address denoting an address of a register Rj corresponding to a flag D0_2consecutive_j having been set to “1” in the slide storage unit. If there is a plurality of flags D0_2consecutive_j set to “1”, the address/length information generating unit 312 generates address information Address of a register R closest to the 0th register R0 out of registers R corresponding to the flags D0_2consecutive_j set to “1”.

The process proceeds to Step S79; at Step S79, the address/length information generating unit 312 sets a flag SlideFLAG to “1”. The address/length information generating unit 312 supplies the length information Length set at the Step S77 described above, the address information Address generated at the Step S78 described above, and the flag SlideFLAG set to “1” at the Step S79 described above to the subsequent code-format generation processing unit 320. Then, the process proceeds to Step S80; at Step S80, the code-format generation processing unit 320 performs the encoding process to be described later. The process proceeds to Step S81; at Step S81, the address/length information generating unit 312 sets values of all flags Rx_FLAG (x=0 to 127) to “1”, and supplies the flags Rx_FLAG (x=0 to 127) set to “1” to the list search processing unit 311.

At the Step S76 described above, when it is determined that the value of the flag D0_2FLAG is not “1”, i.e., the value of the flag D0_2FLAG is “0”, the process proceeds to Step S82. At Step S82, the address/length information generating unit 312 determines whether a value of a flag D0_1FLAG supplied from the list search processing unit 311 is “1”. When it is determined that the value of the flag D0_1FLAG is “1”, the process proceeds to Step S83. At Step S83, the address/length information generating unit 312 sets the flag LISTFLAG to “0”. Furthermore, the address/length information generating unit 312 sets a value obtained by adding “1” to the last length information Length as new length information Length. Moreover, the address/length information generating unit 312 sets the number of pixels to be processed to “1”. Then, the process proceeds to Step S84 at which the address/length information generating unit 312 generates address information Address denoting an address of a register Rx corresponding to a flag D0_match_x set to “1” in the slide storage unit. If there is a plurality of flags D0_match_x set to “1”, the address/length information generating unit 312 generates address information Address of a register R closest to the 0th register RU out of registers R corresponding to the flags D0_match_x set to “1”.

The process proceeds to Step S85; at Step S85, the address/length information generating unit 312 sets a flag SlideFLAG to “1”. The address/length information generating unit 312 supplies the length information Length set at the Step S83 described above, the address information Address generated at the Step S84 described above, and the flag SlideFLAG set to “1” at the Step S85 described above to the subsequent code-format generation processing unit 320. Then, the process proceeds to Step S86; at Step S86, the code-format generation processing unit 320 performs the encoding process to be described later. The process proceeds to Step S87; at Step S87, the address/length information generating unit 312 sets values of all flags Rx_FLAG (x=0 to 127) to “1”, and supplies the flags Rx_FLAG (x=0 to 127) set to “1” to the list search processing unit 311.

At the Step S82 described above, when it is determined that the value of the flag D0_1FLAG is not “1”, i.e., the value of the flag D0_1FLAG is “0”, the process proceeds to Step S88. At Step S88, the address/length information generating unit 312 sets the flag LISTFLAG to “0”. Furthermore, the address/length information generating unit 312 sets a value of the last length information Length as new length information Length. Moreover, the address/length information generating unit 312 sets the number of pixels to be processed to “1”. Then, the process proceeds to Step S89 at which the address/length information generating unit 312 generates address information Address denoting an address of a register Rp corresponding to a flag Rp_FLAG set to “1” in the slide storage unit. If there is a plurality of flags Rp_FLAG set to “1”, the address/length information generating unit 312 generates address information Address of a register R closest to the 0th register R0 out of registers R corresponding to the flags Rp_FLAG set to “1”.

The process proceeds to Step S90; at Step S90, the address/length information generating unit 312 sets a flag SlideFLAG to “1”. The address/length information generating unit 312 supplies the length information Length set at the Step S88 described above, the address information Address generated at the Step S89 described above, and the flag SlideFLAG set to “1” at the Step S90 described above to the subsequent code-format generation processing unit 320. Then, the process proceeds to Step S91; at Step S91, the code-format generation processing unit 320 performs the encoding process to be described later. The process proceeds to Step S92; at Step S92, the address/length information generating unit 312 sets values of all flags Rx_FLAG (x=0 to 127) to “1”, and supplies the flags Rx_FLAG (x=0 to 127) set to “1” to the list search processing unit 311.

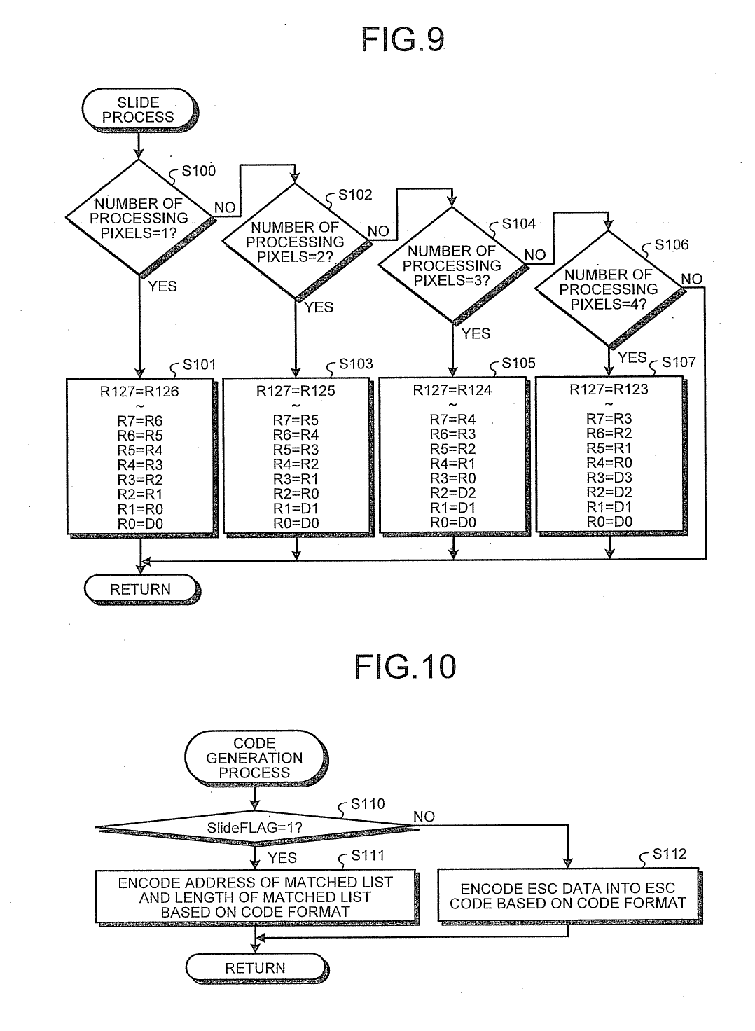

FIG. 9 is a flowchart showing detailed contents of the slide addition process performed at Step S18 in FIG. 6. First, at Step S100, the slide/list generation processing unit 310 determines whether the number of pixels to be processed, that has been set in one of the discontinuous processing and continuous processing described above, is “1”. When it is determined that the number of pixels to be processed is “1”, the process proceeds to. Step S101; at Step S101, the slide/list generation processing unit 310 shifts memory contents of the registers (R0 to R127) in the slide storage unit to the registers on the other end side by one, and inputs only the leading 0th pixel value D0 out of four consecutive pixel values (D0, D1, D2, and D3) included in an input data string to the empty register at one end of the slide storage unit, i.e., adds the pixel value D0 into the 0th register R0.

At the Step S100 described above, when it is determined that the number of pixels to be processed is not “1”, the process proceeds to Step S102. At Step S102, the slide/list generation processing unit 310 determines whether the number of pixels to be processed set in the above-described discontinuous processing or continuous processing is “2”. When it is determined that the number of pixels to be processed is “2”, the process proceeds to Step S103; at Step S103, the slide/list generation processing unit 310 shifts memory contents of the registers (R0 to R127) in the slide storage unit to the registers on the other end side by two, and sequentially inputs the 0th and 1st pixel values D0 and D1 of the input data string to the empty registers in order from the register at one end of the slide storage unit, i.e., adds the pixel value D0 into the 1st register R1 and adds the pixel value D1 into the 0th register R0.

At the Step S102 described above, when it is determined that the number of pixels to be processed is not “2”, the process proceeds to Step S104. At Step S104, the slide/list generation processing unit 310 determines whether the number of pixels to be processed set in the above-described discontinuous processing or continuous processing is “3”. When it is determined that the number of pixels to be processed is “3”, the process proceeds to Step S105; at Step S105, the slide/list generation processing unit 310 shifts memory contents of the registers (R0 to R127) in the slide storage unit to the registers on the other end side by three, and sequentially inputs the 0th to 2nd pixel values D0, D1, and D2 of the input data string to the empty registers in order from the register at one end of the slide storage unit, i.e., adds the pixel value D0 into the 2nd register R2, adds the pixel value D1 into the 1st register R1, and the pixel value D2 into the 0th register R0.

At the Step S104 described above, when it is determined that the number of pixels to be processed is not “3”, the process proceeds to Step S106. At Step S106, the slide/list generation processing unit 310 determines whether the number of pixels to be processed set in the above-described discontinuous processing or continuous processing is “4”. When it is determined that the number of pixels to be processed is “4”, the process proceeds to Step S107; at Step S107, the slide/list generation processing unit 310 shifts memory contents of the registers (R0 to R127) in the slide storage unit to the registers on the other end side by four, and sequentially inputs the four pixel values (D0, D1, D2, and D3) included in the input data string to the empty registers in order from the register at one end of the slide storage unit, i.e., adds the pixel value D0 to the 3rd register R3, adds the pixel value D1 to the 2nd register R2, adds the pixel value D2 to the 1st register R1, and adds the pixel value D3 to the 0th register R0.

FIG. 10 is a flowchart showing detailed contents of the above-described encoding process. First, at Step S110, the code-format generation processing unit 320 determines whether the flag SlideFLAG supplied from the slide/list generation processing unit 310 is “1”. When it is determined that the flag SlideFLAG is “1”, the process proceeds to Step S111; at Step S111, the code-format generation processing unit 320 encodes the address information Address and length information Length supplied from the slide/list generation processing unit 310 into a Slide code as illustrated in FIG. 4.

On the other hand, at the Step S110 described above, when it is determined that the flag SlideFLAG is not “1”, i.e., it is determined that the flag SlideFLAG is “0”, the process proceeds to Step S112; at Step S112, the code-format generation processing unit 320 encodes the ESC data supplied from the slide/list generation processing unit 310 into an ESC code as illustrated in FIG. 4.

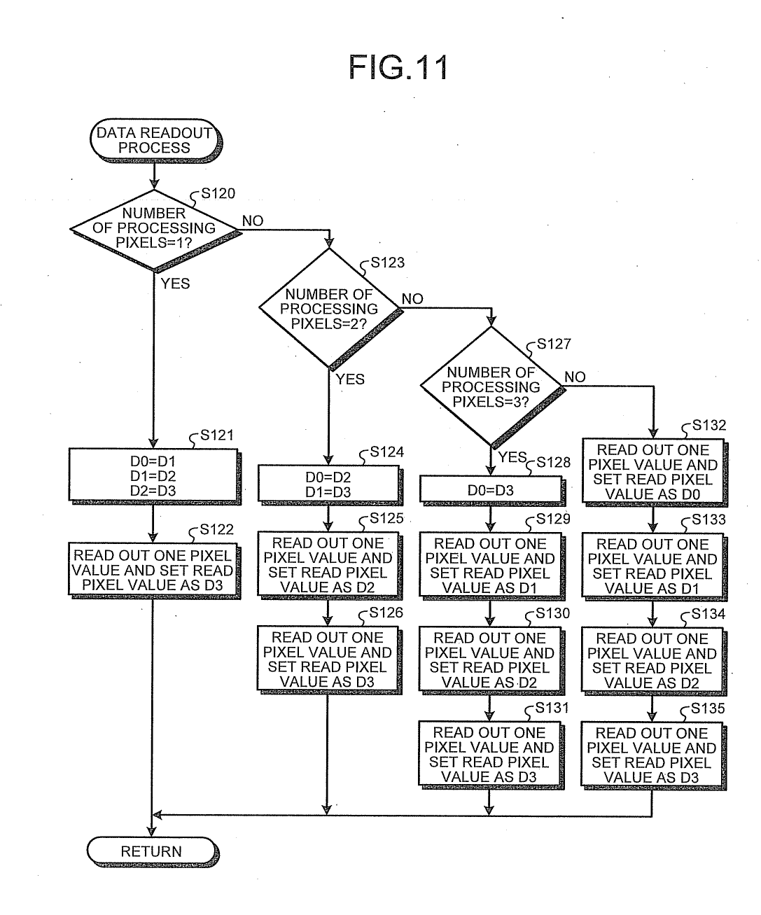

FIG. 11 is a flowchart showing an example of detailed contents of the data readout process performed at Step S13 in FIG. 6. First, at Step S120, the data readout unit 300 determines whether the number of pixels to be processed supplied from the slide/list generation processing unit 310 is “1”. When it is determined that the number of pixels to be processed is “1”, the process proceeds to Step S121. At Step S121, each of four pixel values included in the last input data string is shifted by one. More specifically, the 3rd pixel value D3 of the last input data string is shifted to the 2nd pixel value D2, the 2nd pixel value D2 of the last input data string is shifted to the 1st pixel value D1, the 1st pixel value D1 of the last input data string is shifted to the 0th pixel value D0, and the shifted pixel values are supplied to the slide/list generation processing unit 310. Incidentally, as explained in the slide addition process described above, when the number of pixels to be processed is “1”, the 0th pixel value D0 of the last input data string is input and stored in the slide storage unit. Then, the process proceeds to Step S122; at Step S122, the data readout unit 300 newly reads out a pixel value of one target pixel from the main memory 210, and supplies the read pixel value to the slide/list generation processing unit 310 as the 3rd pixel value D3. In this way, a new input data string (D0, D1, D2, D3) is formed and supplied to the slide/list generation processing unit 310.

At the Step S120 described above, when it is determined that the number of pixels to be processed is not “1”, the process proceeds to Step S123. At Step S123, the data readout unit 300 determines whether the number of pixels to be processed is “2”. When it is determined that the number of pixels to be processed is “2”, the process proceeds to Step S124. At Step S124, each of four pixel values included in the last input data string is shifted by two. More specifically, the 2nd pixel value D2 of the last input data string is shifted to the 0th pixel value D0, the 3rd pixel value D3 of the last input data string is shifted to the 1st pixel value D1, and the shifted pixel values are supplied to the slide/list generation processing unit 310. Incidentally, as explained in the slide addition process described above, when the number of pixels to be processed is “2”, the 0th and 1st pixel values D0 and D1 of the last input data string are sequentially input and stored in the slide storage unit.

Then, the process proceeds to Step S125; at Step S125, the data readout unit 300 newly reads out a pixel value of one target pixel from the main memory 210, and supplies the read pixel value to the slide/list generation processing unit 310 as the 2nd pixel value D2. The process proceeds to Step S126; at Step S126, the data readout unit 300 further reads out a pixel value of one target pixel from the main memory 210, and supplies the read pixel value to the slide/list generation processing unit 310 as the 3rd pixel value D3. In this way, a new input data string is formed and supplied to the slide/list generation processing unit 310.

At the Step S123 described above, when it is determined that the number of pixels to be processed is not “2”, the process proceeds to Step S127. At Step S127, the data readout unit 300 determines whether the number of pixels to be processed is “3”. When it is determined that the number of pixels to be processed is “3”, the process proceeds to Step S128. At Step S128, each of four pixel values included in the last input data string is shifted by three. More specifically, the 3rd pixel value D3 of the last input data string is shifted to the 0th pixel value D0, and the shifted pixel value is supplied to the slide/list generation processing unit 310. As explained in the slide addition process described above, when the number of pixels to be processed is “3”, the 0th to 2nd pixel values D0, D1, and D2 of the last input data string are sequentially input and stored in the slide storage unit.

Then, the process proceeds to Step S129; at Step S129, the data readout unit 300 newly reads out a pixel value of one target pixel from the main memory 210, and supplies the read pixel value to the slide/list generation processing unit 310 as the 1st pixel value D1. At the next Step S130, the data readout unit 300 further reads out a pixel value of one target pixel from the main memory 210, and supplies the read pixel value to the slide/list generation processing unit 310 as the 2nd pixel value D2. At the next Step S131, the data readout unit 300 further reads out a pixel value of one target pixel from the main memory 210, and supplies the read pixel value to the slide/list generation processing unit 310 as the 3rd pixel value D3. In this way, a new input data string is formed and supplied to the slide/list generation processing unit 310.

At the Step S127 described above, when it is determined that the number of pixels to be processed is not “3”, and determined that the number of pixels to be processed is “4”, and the process proceeds to Step S132. As explained in the slide addition process described above, when the number of pixels to be processed is “4”, because the previous 0th and 1st pixel values D0 and D1 are sequentially input and stored in the slide storage unit, all the four pixel values (D0, D1, D2, and D3) included in the last input data string are stored in the slide storage unit. The process proceeds to Step S132; at Step S132, the data readout unit 300 newly reads out a pixel value of one target pixel from the main memory 210, and supplies the read pixel value to the slide/list generation processing unit 310 as the 0th pixel value D0. At the next Step S133, the data readout unit 300 further reads out a pixel value of one target pixel from the main memory 210, and supplies the read pixel value to the slide/list generation processing unit 310 as the 1st pixel value D1. At the next Step S134, the data readout unit 300 further reads out a pixel value of one target pixel from the main memory 210, and supplies the read pixel value to the slide/list generation processing unit 310 as the 2nd pixel value D2. At the next Step S135, the data readout unit 300 further reads out a pixel value of one target pixel from the main memory 210, and supplies the read pixel value to the slide/list generation processing unit 310 as the 3rd pixel value D3. In this way, a new input data string is formed and supplied to the slide/list generation processing unit 310.

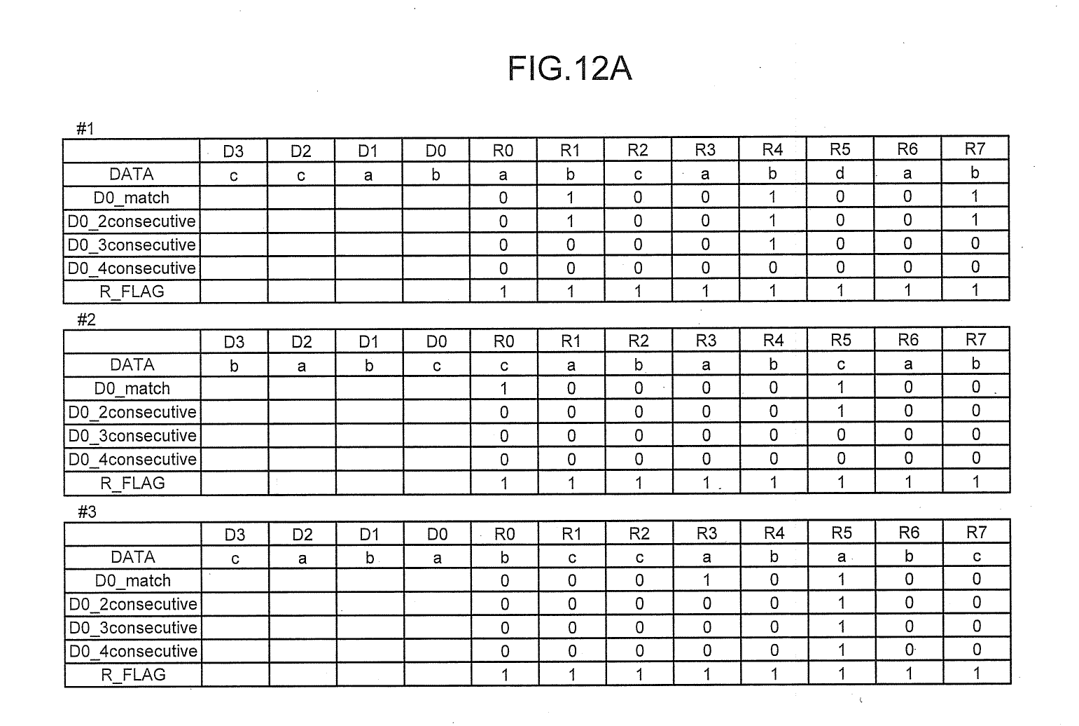

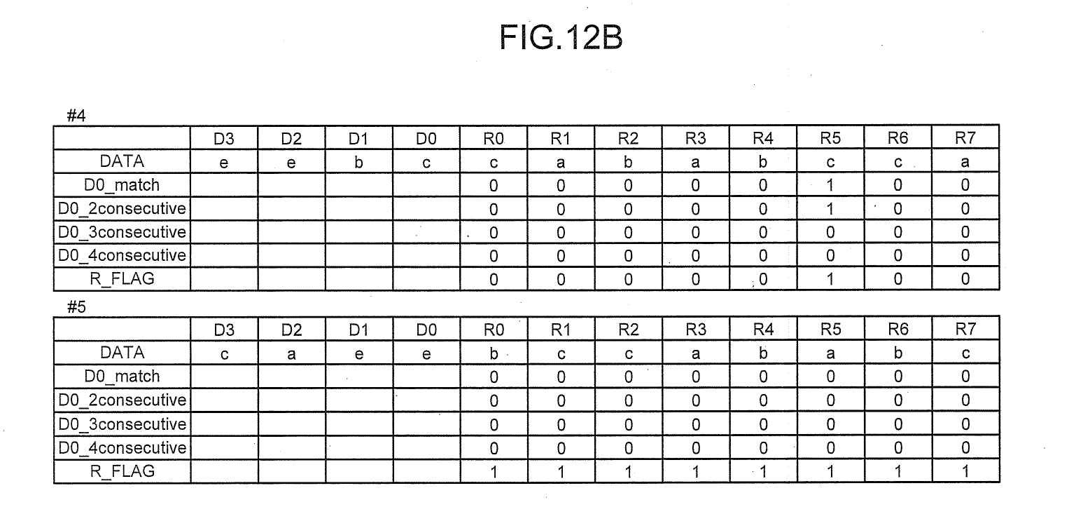

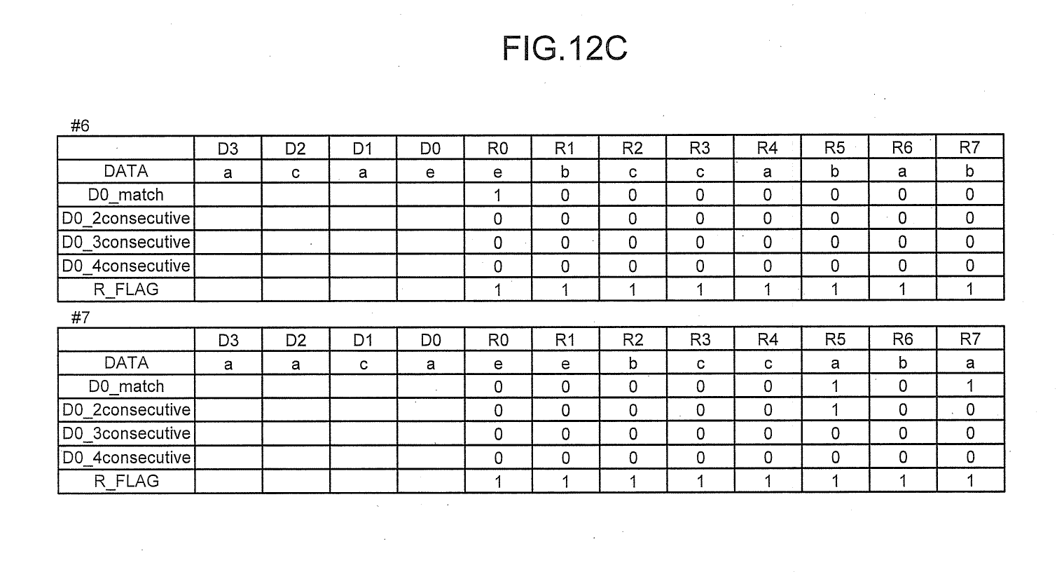

Subsequently, a concrete example of the encoding process according to the embodiment is explained with reference to FIG. 12. As described above, in the embodiment, the slide storage unit has 128 registers R (R0 to R127); however, in the example shown in FIG. 12, for convenience of explanation, the explanation is focused 7 registers R (the 0th register R0 to the 7th register R7).

In the first process #1, a pixel value “a” is stored in the 0th register R0, a pixel value “b” is stored in the 1st register R1, a pixel value “c” is stored in the 2nd register R2, the pixel value “a” is stored in the 3rd register R3, the pixel value “b” is stored in the 4th register R4, a pixel value “d” is stored in the 5th register R5, the pixel value “a” is stored in the 6th register R6, and the pixel value “b” is stored in the 7th register R7. As shown in FIG. 12, an input data string at this point is “b, a, c, c”, i.e., the 0th pixel value D0 is “b”, the 1st pixel value D1 is “a”, the 2nd pixel value D2 is “c”, and the 3rd pixel value D3 is “c”. Here, the process #1 is assumed to be discontinuous processing. Therefore, values of flags Rx_FLAG (x=0 to 127) are all set to “1”.

In the process #1, data (“b”) stored in the 4th register R4 matches the 0th pixel value D0 (“b”), data (“a”) stored in the 3rd register R3 matches the 1st pixel value D1 (“a”), and data (“c”) stored in the 2nd register R2 matches the 2nd pixel value D2 (“c”). Therefore, a list formed by the three consecutive pixel values, that are the 0th pixel value D0, the 1st pixel value D1, and the 2nd pixel value D2, is present in the slide storage unit, and a flag D0_3consecutive_4 indicating that the pixel value D0, which is leading data of the list, has been stored in the 4th register R4 is set to “1”. Furthermore, at this time, a flag D0_2consecutive_4 and a flag D0_match_4 are also set to “1”; however, as explained in the discontinuous processing shown in FIG. 7, processing when the flag D0_3consecutive_4 is set to “1” is given priority over processing when the flag D0_2consecutive_4 and the flag D0match_4 are set to “1”, so that the length information Length denoting the length of the list is set to “3”, and the address information Address denoting an address of the 4th register R4 is generated. Then, the address information Address and the length information Length are encoded.

Next, each of memory contents of the registers (R0 to R127) in the slide storage unit is shifted to the right in FIG. 12 by three, and “b” that is the 0th pixel value D0 of the input data string, “a” that is the 1st pixel value D1, and “c” that is the 2nd pixel value D2 are sequentially input to the registers from the left in FIG. 12, i.e., “b”, which is the 0th pixel value D0, is stored in the 2nd register R2, “a”, which is the 1st pixel value D1, is stored in the 1st register R1, and “c”, which is the 2nd pixel value D2, is stored in the 0th register R0. Then, the encoding process moves on to the next process #2. In the above process #1, a list that exactly matches the input data string is not present in the slide storage unit (there is no flag D0_4consecutive_p set to “1”), so that the next process #2 is to be discontinuous processing.

As the number of pixels to be processed in the process #1 is “3”, in the process #2, “c”, that is the 3rd pixel value D3 of the last input data string (in the process #1), is shifted as the 0th pixel value D0, and pixel values of three target pixels are newly read out. In the example shown in FIG. 12, a newly-read pixel value “b” is set as the 1st pixel value D1, a newly-read pixel value “a” is set as the 2nd pixel value D2, and a newly-read pixel value “b” is set as the 3rd pixel value D3. Namely, an input data string in the process #2 is “c (the 0th ), b (the 1st), a (the 2nd), b (the 3rd)”.

In the process #2, data (“c”) stored in the 5th register R5 matches the 0th pixel value D0 (“c”), and data (“b”) stored in the 4th register R4 matches the 1st pixel value D1 (“b”). Therefore, a list that includes the two consecutive 0th and 1st pixel values D0 and D1 is present in the slide storage unit, and a flag D0_2consecutive_5 indicating that the pixel value D0, leading data of the list, has been stored in the 5th register R5 is set to “1”. Furthermore, at this time, a flag D0_match_5 is also set to “1”; however, as explained in the discontinuous processing shown in FIG. 7, processing when the flag D0_2consecutive_5 is set to “1” is given priority, so that a value of length information Length denoting the length of the list is set to “2”, and address information Address denoting an address of the 5th register R5 is generated. Then, the address information Address and the length information Length are encoded.

Next, each of memory contents of the registers (R0 to R127) in the slide storage unit is shifted to the right in FIG. 12 by two, and “c” that is the 0th pixel value D0 of the input data string and “b” that is the 1st pixel value D1 are sequentially input to the empty registers in order from the register on the left side in FIG. 12, i.e., “c”, the 0th pixel value D0, is stored in the 1st register R1, and “b”, the 1st pixel value D1, is stored in the 0th register R0. Then, the encoding process moves on to the next process #3. In the above process #2, a list that exactly matches the input data string is not present in the slide storage unit (there is no flag D0_4consecutive_p set to “1”), so that the next process #3 is to be discontinuous processing.

As the number of pixels to be processed in the process #2 is “2”, in the process #3, “a”, that is the 2nd pixel value D2 of the last input data string (in the process #2), is shifted as the 0th pixel value D0, and “b”, that is the 3rd pixel value D3 of the last input data string, is shifted as the 1st pixel value D1, and then pixel values of two target pixels are newly read out. In the example shown in FIG. 12, a newly-read pixel value “a” is set as the 2nd pixel value D2, and a newly-read pixel value “c” is set as the 3rd pixel value D3. Namely, an input data string in the process #3 is “a (the 0th ), b (the 1st), a (the 2nd), c (the 3rd)”.

In the process #3, data (“a”) stored in the 5th register R5 matches the 0th pixel value D0 (“a”), data (“b”), stored in the 4th register R4 matches the 1st pixel value D1 (“b”), data (“a”) stored in the 3rd register R3 matches the 2nd pixel value D2 (“a”), and data (“c”) stored in the 2nd register R2 matches the 3rd pixel value D3 (“c”). Therefore, a list that exactly matches the input data string is present in the slide storage unit, and a flag D0_4consecutive_5 indicating that the pixel value D0, leading data of the list, has been stored in the 5th register R5 is set to “1”. Furthermore, at this time, a flag D0_3consecutive_5, a flag D0_2consecutive_5, and a flag D0_match_5 are also set to “1”; however, as explained in the discontinuous processing shown in FIG. 7, processing when the flag D0_4consecutive_5 is set to “1” is given priority, so that a value of length information Length denoting the length of the list is set to “4”, and a flag R5 FLAG denoting the availability of the 5th registers R5 is kept to “1”, while a flag R_FLAG denoting the availability of another registers R is set to “0”.

Then, each of memory contents of the registers (R0 to R127) in the slide storage unit is shifted to the right in FIG. 12 by four, and four pixel values (a, b, a, c) included in the input data string are sequentially input to the registers in order from the register on the left side in FIG. 12, i.e., “a”, the 0th pixel value D0, is stored in the 3rd register R3, and “b”, the 1st pixel value D1, is stored in the 2nd register R2, and “a”, the 2nd pixel value D2, is stored in the 1st register R1, and “c”, the 3rd pixel value D3, is stored in the 0th register R0. Then, the encoding process moves on to the next process #4. In the above process #3, a list that exactly matches the input data string is present in the slide storage unit (there is a flag D0_4consecutive_p set to “1”), so that the next process #4 is to be continuous processing.

As the number of pixels to be processed in the process #3 is “4”, in the next process #4, pixel values of four target pixels are newly read out. In the example shown in FIG. 12, a newly-read pixel value “c” is set as the 0th pixel value D0, a newly-read pixel value “b” is set as the 1st pixel value D1, a newly-read pixel value “e” is set as the 2nd pixel value D2, and a newly-read pixel value “e” is set as the 3rd pixel value D3. Namely, an input data string in the process #4 becomes “c (the 0th ), b (the 1st), e (the 2nd), e (the 3rd)”.

In the process #4, data (“c”) stored in the 5th register R5 matches the 0th pixel value D0 (“c”), and data (“b”) stored in the 4th register R4 matches the 1st pixel value D1 (“b”). Therefore, a list that includes the two consecutive 0th and 1st pixel values D0 and D1 is present in the slide storage unit, and a flag D0_2consecutive_5 indicating that the pixel value D0, leading data of the list, has been stored in the 5th register R5 is set to “1”. Furthermore, at this time, a flag D0_match_5 is also set to “1”; however, processing when the flag D0_2consecutive_5 is set to “1” is given priority, so that a value “6” obtained by adding “4”, the value of the last length information Length, to “2” indicating the length of the list retrieved in the process #4 is set as length information Length, and address information Address denoting an address of the 5th register R5 is generated. Then, the address information Address and the length information Length are encoded.

Next, each of memory contents of the registers (R0 to R127) in the slide storage unit is shifted to the right in FIG. 12 by two, and “c” that is the 0th pixel value D0 of the input data string and “b” that is the 1st pixel value D1 are sequentially input to the registers from the left side in FIG. 12, i.e., “c”, which is the 0th pixel value D0, is stored in the 1st register R1, and “b”, which is the 1st pixel value D1, is stored in the 0th register R0. Then, the encoding process moves on to the next process #5. In the above process #4, a list that exactly matches the input data string is not present in the slide storage unit (there is no flag D0_4consecutive_p set to “1”), so that the next process #5 is to be discontinuous processing, and values of flags Rx_FLAG (x=0 to 127) are all set to “1” again.

As the number of pixels to be processed in the process #4 is “2”, in the next process #5, “e”, that is the 2nd pixel value D2 of the last input data string (in the process #4), is shifted as the 0th pixel value D0, and “e”, that is the 3rd pixel value D3 of the last input data string, is shifted as the 1st pixel value D1, and then pixel values of two target pixels are newly read out. In the example shown in FIG. 12, a newly-read pixel value “a” is set as the 2nd pixel value D2, and a newly-read pixel value “c” is set as the 3rd pixel value D3. Namely, an input data string in the process #5 is “e (the 0th ), e (the 1st), a (the 2nd), c (the 3rd)”.

In the process #5, a list that includes any of data (pixel values) stored in the 0th to 7th registers R0 to R7 matching the 0th pixel value D0 (“e”) of the input data string is not present, so that an ESC code is generated by encoding the 0th pixel value D0. Then, each of memory contents of the registers (R0 to R127) in the slide storage unit is shifted to the right in FIG. 12 by one, and only “e”, the 0th pixel value D0 of the input data string, is input to the empty register on the left side in FIG. 12, i.e., “e” is stored in the 0th register R0. Then, the encoding process moves on to the next process #6. In the above process #5, a list that exactly matches the input data string is not present in the slide storage unit (there is no flag D0_4consecutive_p set to “1”), so that the next process #6 is to be discontinuous processing.

As the number of pixels to be processed in the process #5 is “1”, in the next process #6, “e”, that is the 1st pixel value D1 of the last input data string (in the process #5), is shifted as the 0th pixel value D0, “a”, that is the 2nd pixel value D2 of the last input data string, is shifted as the 1st pixel value D1, “c”, that is the 3rd pixel value D3 of the last input data string, is shifted as the 2nd pixel value D2, and then a pixel value of one target pixel is newly read out. In the example shown in FIG. 12, a newly-read pixel value “a” is set as the 3rd pixel value D3. Namely, an input data string in the process #6 becomes “e (the 0th ), a (the 1st), c (the 2nd), a (the 3rd)”.

In the process #6, a pixel value (“e”) stored in the 0th register R0 matches the 0th pixel value D0 (“e”) of the input data string, so that a flag D0_match_0 is set to “1”, while the other flags are all set to “0”. Namely, in the process #6, a list matching two or more consecutive pixel values of the input data string is not present in the slide storage unit, so that an ESC code is generated by encoding the 0th pixel value D0 of the input data string. Then, each of memory contents of the registers (R0 to R127) in the slide storage unit is shifted to the right in FIG. 12 by one, and only “e”, that is the 0th pixel value D0 of the input data string, is input to the empty register on the left side in FIG. 12, i.e., “e” is stored in the 0th register R0. Then, the encoding process moves on to the next process #7. In the above process #6, a list that exactly matches the input data string is not present in the slide storage unit (there is no flag D0_4consecutive_p set to “1”), so that the next process #7 is to be discontinuous processing.

Because the number of pixels to be processed in the process #6 is “1”, in the next process #7, “a”, that is the 1st pixel value D1 of the last input data string (in the process #6), is shifted as the 0th pixel value D0, “c”, that is the 2nd pixel value D2 of the last input data string, is shifted as the 1st pixel value D1, “a”, that is the 3rd pixel value D3 of the last input data string, is shifted as the 2nd pixel value D2, and then a pixel value of one target pixel is newly read out. In the example shown in FIG. 12, a newly-read pixel value “a” is set as the 3rd pixel value D3. Namely, an input data string in the process #6 is “a (the 0th ), c (the 1st), a (the 2nd), a (the 3rd)”.

In the process #7, data (“a”) stored in the 5th register R5 matches the 0th pixel value D0 (“a”), and data (“c”) stored in the 4th register R4 matches the 1st pixel value D1 (“c”). Therefore, a flag D0_2consecutive_5 is set to “1”, so that a value of length information Length denoting the length of the list is set to “2”, and address information Address denoting an address of the 5th register R5 is generated. Then, the address information Address and the length information Length are encoded.

Next, each of memory contents of the registers (R0 to R127) in the slide storage unit is shifted to the right in FIG. 12 by two, and “a” that is the 0th pixel value D0 of the input data string and “c” that is the 1st pixel value D1 are sequentially input to the registers from the left side in FIG. 12, i.e., “a”, that is the 0th pixel value D0, is stored in the 1st register R1, and “c”, that is the 1st pixel value D1, is stored in the 0th register R0. Then, the encoding process moves on to the next process. In the above process #7, a list that exactly matches the input data string is not present in the slide storage unit (there is no flag D0_4consecutive_p set to “1”), so that the next process is to be discontinuous processing.

### Operation and Effect

As described above, in the embodiment, the list search process is performed on the basis of the logical conjunction of at least two output signals out of output signals from the comparators (313, 314, 315, 316), so that it is sufficient to provide an AND gate (AND circuit), and a counter and a selector are not required. Therefore, according to the embodiment, it is possible to reduce the circuit size as compared with a conventional configuration.

### Modification

Incidentally, in the above embodiment, the embodiment is described to be applied to a printer device; however, this is only an example, and the embodiment is not limited thereto. Namely, the embodiment can be applied to other devices that perform lossless encoding of data using hardware. Furthermore, in the above embodiment, a configuration of an input data string that includes four pixels is described as an example; however, a configuration of an input data string is not limited thereto, and the number of pixels included in an input data string can be arbitrary. Moreover, in the above embodiment, the slide storage unit includes 128 registers R; however, the number of registers R is not limited to 128, and the number of registers R included in the slide storage unit can be arbitrary. Furthermore, in the above embodiment, the list search processing unit includes the OR gates 380 to 410; however, the configuration of the list search processing unit is not limited thereto, and, for example, the list search processing unit can be configured not to include the OR gates 380 to 410. In short, in the embodiment, it is sufficient to provide at least an AND gate.

According to the embodiments, the list search process is performed on the basis of the logical conjunction of L (L is a natural number equal to or greater than two) pieces of comparison-result signals out of a plurality of comparison-result signals, so that it is sufficient for an arithmetic circuit to include an AND gate, and a counter and a selector are not required. Therefore, it is possible to reduce the size of the circuit as compared to a conventional configuration.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
a first storage unit into which a pixel value of each of a plurality of pixels included in image data is written;
a readout unit that reads out a pixel value of a target pixel to be encoded from the first storage unit;
a second storage unit into which the pixel value having been read by the readout unit is stored;
a comparison-result-signal generating unit
that makes a comparison between each pixel value of a plurality of the consecutive target pixels having been read by the readout unit and each of a plurality of the pixel values having been stored in the second storage unit, and
that generates a comparison-result signal representing a result of the comparison as a binary signal;
a searching unit that searches the second storage unit for a data string that includes L pieces (L is a natural number equal to or greater than two) of the consecutive pixel values that match other L pieces of consecutive pixel values of an input data string that includes each pixel value of a plurality of the consecutive target pixels based on a result of a logical conjunction of L pieces of the comparison-result signals out of a plurality of the comparison-result signals generated by the comparison-result-signal generating unit; and
an encoding unit that performs encoding according to a result of a search by the searching unit.

2. The image processing apparatus according to claim 1, wherein
the encoding unit includes:
a length-information generating unit that generates, when the data string is searched by the searching unit, length information indicating a length of the searched data string;
an address-information generating unit that generates, when the data string is searched by the searching unit, address information indicating an address of leading data of the searched data string stored in the second storage unit;
a first-code-data generating unit that generates first code data in which the length information and the address information are encoded; and
a second-code-data generating unit that generates, when the data string is not searched by the searching unit, second code data in which a pixel value of the leading target pixel in a plurality of the consecutive target pixels having been read by the readout unit is encoded.

3. The image processing apparatus according to claim 2, further comprising
a target-pixel-number setting unit
that sets, when the data string is searched by the searching unit, a first number of the pixel values included in the searched data string as a second number of the target pixels to be read by the readout unit in a next readout, and
that sets, when the data string is not searched by the searching unit, the second number of the target pixels to be read by the readout unit in the next readout to one, wherein
after performing encoding by the encoding unit, each of the pixel values of a third number of the target pixels beginning from the leading target pixel, with the third number being set by the target-pixel-number setting unit, out of the plurality of the consecutive target pixels is sequentially input from one end of the second storage unit and stored in the second storage unit, and the pixel values that have been stored in the second storage unit are shifted toward another end of the second storage unit to be stored therein.

4. An image processing method comprising:
reading a pixel value of a target pixel to be encoded from a first storage unit in which each pixel value of a plurality of pixels included in image data is written;
comparing between each pixel value of a plurality of the consecutive target pixels read by the reading and each of a plurality of the pixel values that have been stored in a second storage unit in which the pixel values are stored and generating, for each comparison, a comparison-result signal representing a result of the comparison as a binary signal;
searching the second storage unit for a data string that includes L pieces (L is a natural number equal to or greater than two) of the consecutive pixel values that match other L pieces of the consecutive pixel values of an input data string that includes each pixel value of a plurality of the consecutive target pixels based on a result of a logical conjunction of L pieces of the comparison-result signals out of a plurality of the comparison-result signals generated by the comparing; and
encoding according to a result of a search by the searching.
